(19) United States
(12) Patent Application Publication
(10) Pub. No.: US 2026/0205838 A1
(43) Pub. Date: Jul. 16, 2026

(54) METHODS, ARCHITECTURES, APPARATUSES AND SYSTEMS FOR INCREMENTAL CHANNEL STATE INFORMATION ESTIMATION

(71) Applicant: InterDigital Patent Holdings, Inc., Wilmington, DE (US)

(72) Inventors: Javier Lorca Hernando, Madrid (ES); Arman Shojaeifard, London (GB); Ghyslain Pelletier, Montreal (CA); Alain Mourad, London (GB); Ibrahim Hemadeh, London (GB)

(21) Appl. No.: 19/016,734

(22) Filed: Jan. 10, 2025

(51) Int. Cl. H04W 24/08; H04L 5/00

(52) U.S. Cl. CPC H04W 24/08; H04L 5/005

(57) ABSTRACT

This disclosure relates to selecting, by a wireless transmit/receive unit (WTRU), one or more reference signal (RS) configurations for incremental channel state information (CSI) estimation. A WTRU may receive, from a wireless network entity, first configuration information for performing task measurements and for determining incremental CSI. The WTRU may receive a first RS. The WTRU may perform task measurements based on the first RS and on first configuration information. The WTRU may determine incremental CSI based on the first RS and on first configuration information, wherein the incremental CSI comprises long-term and short-term magnitude information. The WTRU may determine one or more RS configurations to recommend to the wireless network entity for incremental CSI estimation based on the incremental CSI. The WTRU may transmit, to the wireless network entity, information indicative of the one or more RS configurations to recommend to the wireless network entity for incremental CSI estimation.

### TECHNICAL FIELD

The present disclosure is generally directed to the fields of communications, software and encoding, including, for example, to methods, architectures, apparatuses, systems related to estimating incremental channel state information, which includes long-term and short-term channel information, in sensing, positioning or communication tasks.

### SUMMARY

In accordance with certain representative embodiments of the present disclosure, methods and systems are provided for selecting, by a wireless transmit/receive unit (WTRU), one or more RS configurations for incremental channel state information (CSI) estimation. In certain representative embodiments, a WTRU may receive, from a wireless network entity, first configuration information for performing task measurements (i.e., one or more of sensing, positioning, communication, or incremental CSI measurements) and for determining incremental CSI. The WTRU may receive, from the wireless network entity, a first reference signal (RS). The WTRU may perform task measurements based on the first RS and on the first configuration information. The WTRU may determine incremental CSI based on the first RS and on the first configuration information, wherein the incremental CSI comprises long-term magnitude information over a first interval of the RS and short-term magnitude information over a second interval of the RS that is shorter than the first interval. The first interval may comprise a duration over one or more symbol intervals, and the second interval may comprise a duration over a subset of a symbol interval. The WTRU may determine one or more RS configurations to recommend to the wireless network entity for incremental CSI estimation based on the incremental CSI. The WTRU may transmit, to the wireless network entity, information indicative of the one or more RS configurations to recommend to the wireless network entity for incremental CSI estimation.

### BRIEF DESCRIPTION OF THE DRAWINGS

A more detailed understanding may be had from the detailed description below, given by way of example in conjunction with drawings appended hereto. Figures in such drawings, like the detailed description, are examples. As such, the Figures (FIGS.) and the detailed description are not to be considered limiting, and other equally effective examples are possible and likely. Furthermore, like reference numerals (“ref.”) in the FIGS. indicate like elements, and wherein:

FIG. 1A is a system diagram illustrating an example communications system, according to one or more embodiments of this disclosure;

FIG. 1B is a system diagram illustrating an example wireless transmit/receive unit (WTRU) that may be used within the communications system illustrated in FIG. 1A, according to one or more embodiments of this disclosure;

FIG. 1C is a system diagram illustrating an example radio access network (RAN) and an example core network (CN) that may be used within the communications system illustrated in FIG. 1A, according to one or more embodiments of this disclosure

FIG. 1D is a system diagram illustrating a further example RAN and a further example CN that may be used within the communications system illustrated in FIG. 1A, according to one or more embodiments of this disclosure;

FIG. 2 is an example of channel estimation at a WTRU capturing the combined effects of path loss, reflection, and diffraction from a surrounding environment, according to one or more embodiments of this disclosure;

FIG. 3 is a diagram of intra-symbol channel variations being used to derivate a set of piecewise channel transfer functions for equalization, according to one or more embodiments of this disclosure;

FIG. 4 is a diagram of a generic baseband transmitter architecture for waveforms with frequency domain equalization (FDE) capabilities, according to one or more embodiments of this disclosure;

FIG. 5 is a diagram of an RS structure composed of two RS configurations which may be suitable for incremental CSI estimation if the channel's coherence time is longer than a symbol duration, according to one or more embodiments of this disclosure;

FIG. 6 is a diagram of an RS configuration which may be suitable for incremental CSI estimation when the channel's coherence time is comparable to a symbol duration, according to one or more embodiments of this disclosure;

FIG. 7 is an example report from a WTRU which includes different types of information, according to one or more embodiments of this disclosure;

FIG. 8 is a flowchart outlining a procedure for WTRU-assisted selection of RS configurations for incremental CSI estimation, according to one or more embodiments of this disclosure;

FIG. 9 is a flowchart outlining a procedure for incremental CSI estimation and reporting, according to one or more embodiments of this disclosure; and

FIG. 10 is a flowchart of illustrative steps for determining configuration information for incremental CSI estimation, according to one or more embodiments of this disclosure.

### DETAILED DESCRIPTION

In the following detailed description, numerous specific details are set forth to provide a thorough understanding of embodiments and/or examples disclosed herein. However, it will be understood that such embodiments and examples may be practiced without some or all of the specific details set forth herein. In other instances, well-known methods, procedures, components and circuits have not been described in detail, so as not to obscure the following description. Further, embodiments and examples not specifically described herein may be practiced in lieu of, or in combination with, the embodiments and other examples described, disclosed or otherwise provided explicitly, implicitly and/or inherently (collectively “provided”) herein. Although various embodiments are described and/or claimed herein in which an apparatus, system, device, etc. and/or any element thereof carries out an operation, process, algorithm, function, etc. and/or any portion thereof, it is to be understood that any embodiments described and/or claimed herein assume that any apparatus, system, device, etc. and/or any element thereof is configured to carry out any operation, process, algorithm, function, etc. and/or any portion thereof.

### Example Communications System

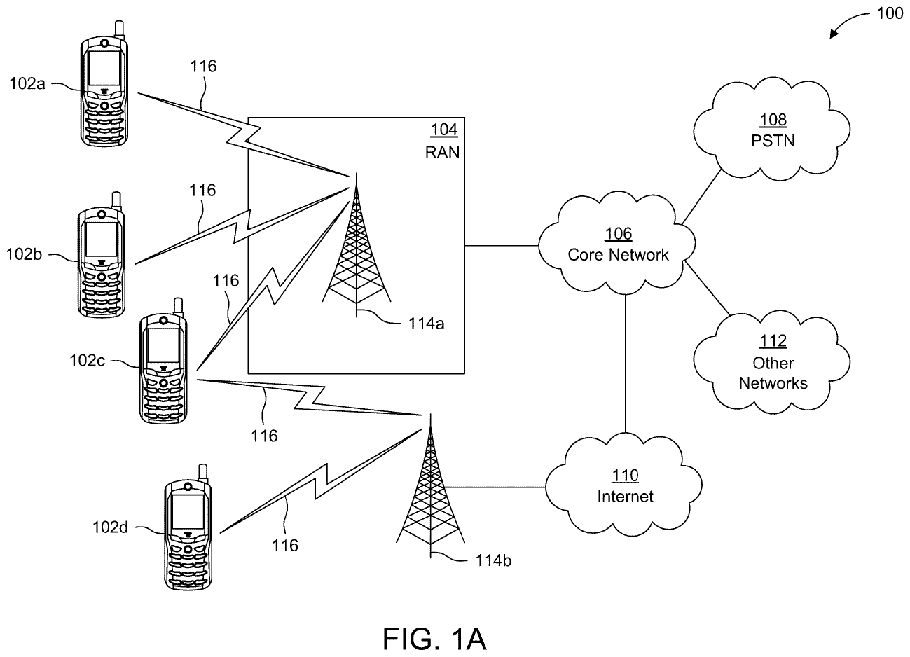

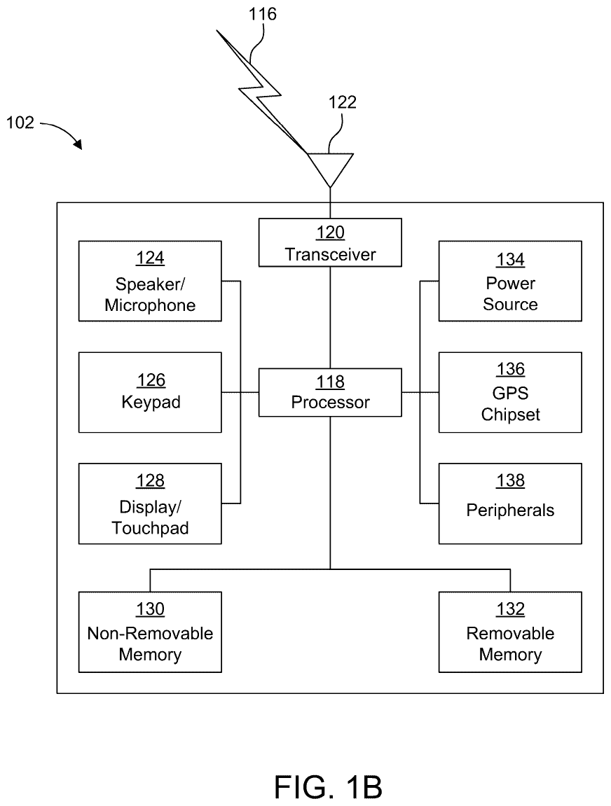

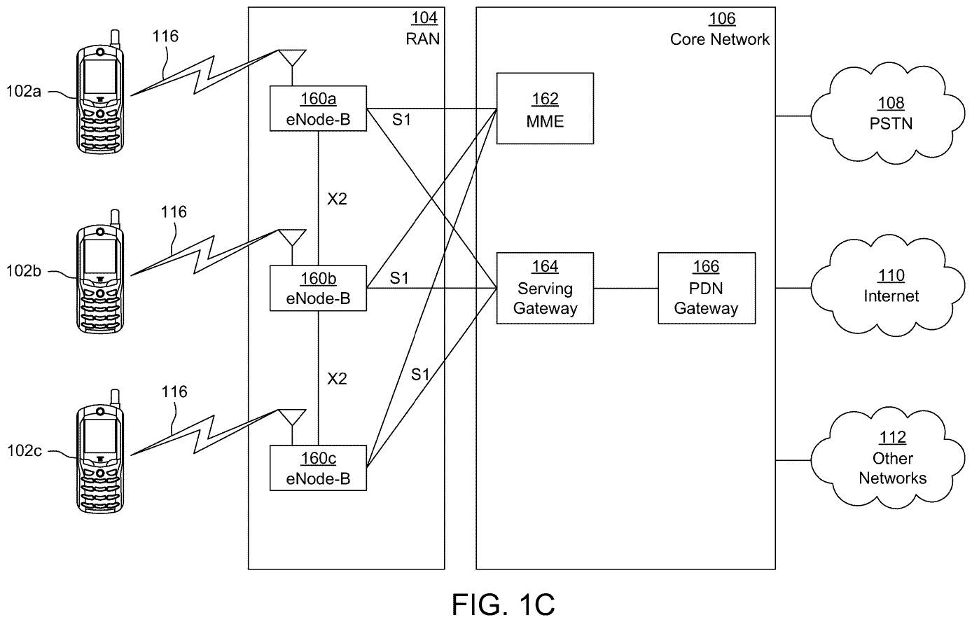

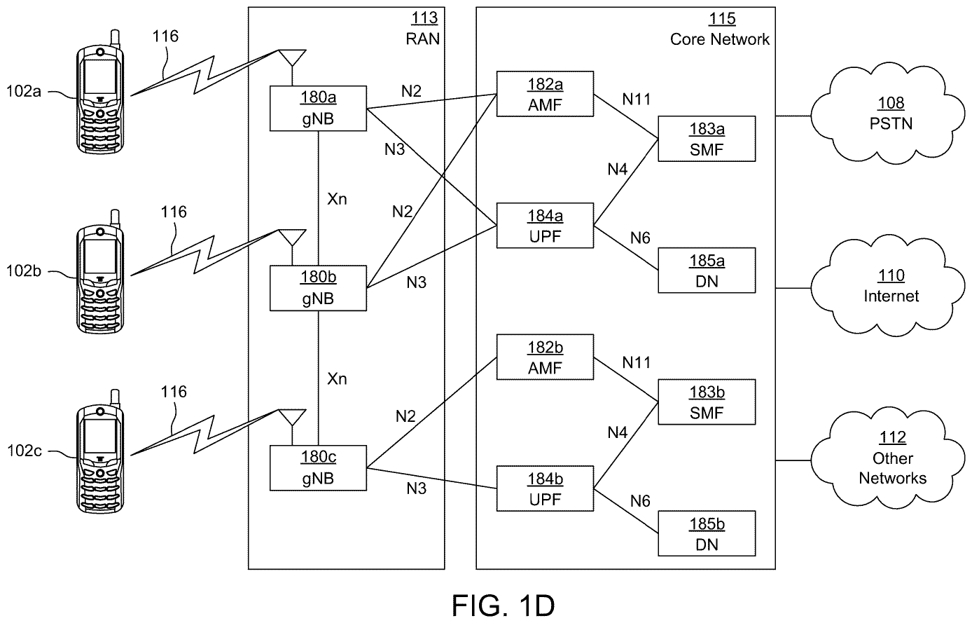

The methods, apparatuses and systems provided herein are well-suited for communications involving both wired and wireless networks. An overview of various types of wireless devices and infrastructure is provided with respect to FIGS. 1A-1D, where various elements of the network may utilize, perform, be arranged in accordance with and/or be adapted and/or configured for the methods, apparatuses and systems provided herein.

FIG. 1A is a system diagram illustrating an example communications system 100 in which one or more disclosed embodiments may be implemented. The communications system 100 may be a multiple access system that provides content, such as voice, data, video, messaging, broadcast, etc., to multiple wireless users. The communications system 100 may enable multiple wireless users to access such content through the sharing of system resources, including wireless bandwidth. For example, the communications systems 100 may employ one or more channel access methods, such as code division multiple access (CDMA), time division multiple access (TDMA), frequency division multiple access (FDMA), orthogonal FDMA (OFDMA), single-carrier FDMA (SC-FDMA), zero-tail (ZT) unique-word (UW) discreet Fourier transform (DFT) spread OFDM (ZT UW DTS-s OFDM), unique word OFDM (UW-OFDM), resource block-filtered OFDM, filter bank multicarrier (FBMC), and the like.

As shown in FIG. 1A, the communications system 100 may include wireless transmit/receive units (WTRUs) 102a, 102b, 102c, 102d, a radio access network (RAN) 104/113, a core network (CN) 106/115, a public switched telephone network (PSTN) 108, the Internet 110, and other networks 112, though it will be appreciated that the disclosed embodiments contemplate any number of WTRUs, base stations, networks, and/or network elements. Each of the WTRUs 102a, 102b, 102c, 102d may be any type of device configured to operate and/or communicate in a wireless environment. By way of example, the WTRUs 102a, 102b, 102c, 102d, any of which may be referred to as a “station” and/or a “STA”, may be configured to transmit and/or receive wireless signals and may include (or be) one or more user equipment (UE) components, a mobile station, a fixed or mobile subscriber unit, a subscription-based unit, a pager, a cellular telephone, a personal digital assistant (PDA), a smartphone, a laptop, a netbook, a personal computer, a wireless sensor, a hotspot or Mi-Fi device, an Internet of Things (IoT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks, and the like. Any of the WTRUs 102a, 102b, 102c and 102d may be interchangeably referred to as a UE, if that WTRU includes only one active UE.

The communications systems 100 may also include a base station 114a and/or a base station 114b. Each of the base stations 114a, 114b may be any type of device configured to wirelessly interface with at least one of the WTRUs 102a, 102b, 102c, 102d, e.g., to facilitate access to one or more communication networks, such as the CN 106/115, the Internet 110, and/or the networks 112. By way of example, the base stations 114a, 114b may be any of a base transceiver station (BTS), a Node-B (NB), an eNode-B (eNB), a Home Node-B (HNB), a Home eNode-B (HeNB), a gNode-B (gNB), a NR Node-B (NR NB), a site controller, an access point (AP), a wireless router, and the like. While the base stations 114a, 114b are each depicted as a single element, it will be appreciated that the base stations 114a, 114b may include any number of interconnected base stations and/or network elements.

The base station 114a may be part of the RAN 104/113, which may also include other base stations and/or network elements (not shown), such as a base station controller (BSC), a radio network controller (RNC), relay nodes, etc. The base station 114a and/or the base station 114b may be configured to transmit and/or receive wireless signals on one or more carrier frequencies, which may be referred to as a cell (not shown). These frequencies may be in licensed spectrum, unlicensed spectrum, or a combination of licensed and unlicensed spectrum. A cell may provide coverage for a wireless service to a specific geographical area that may be relatively fixed or that may change over time. The cell may further be divided into cell sectors. For example, the cell associated with the base station 114a may be divided into three sectors. Thus, in an embodiment, the base station 114a may include three transceivers, i.e., one for each sector of the cell. In an embodiment, the base station 114a may employ multiple-input multiple output (MIMO) technology and may utilize multiple transceivers for each or any sector of the cell. For example, beamforming may be used to transmit and/or receive signals in desired spatial directions.

The base stations 114a, 114b may communicate with one or more of the WTRUs 102a, 102b, 102c, 102d over an air interface 116, which may be any suitable wireless communication link (e.g., radio frequency (RF), microwave, centimeter wave, micrometer wave, infrared (IR), ultraviolet (UV), visible light, etc.). The air interface 116 may be established using any suitable radio access technology (RAT).

More specifically, as noted above, the communications system 100 may be a multiple access system and may employ one or more channel access schemes, such as CDMA, TDMA, FDMA, OFDMA, SC-FDMA, and the like. For example, the base station 114a in the RAN 104/113 and the WTRUs 102a, 102b, 102c may implement a radio technology such as Universal Mobile Telecommunications System (UMTS) Terrestrial Radio Access (UTRA), which may establish the air interface 116 using wideband CDMA (WCDMA). WCDMA may include communication protocols such as High-Speed Packet Access (HSPA) and/or Evolved HSPA (HSPA+). HSPA may include High-Speed Downlink Packet Access (HSDPA) and/or High-Speed Uplink Packet Access (HSUPA).

In an embodiment, the base station 114a and the WTRUs 102a, 102b, 102c may implement a radio technology such as Evolved UMTS Terrestrial Radio Access (E-UTRA), which may establish the air interface 116 using Long Term Evolution (LTE) and/or LTE-Advanced (LTE-A) and/or LTE-Advanced Pro (LTE-A Pro).

In an embodiment, the base station 114a and the WTRUs 102a, 102b, 102c may implement a radio technology such as NR Radio Access, which may establish the air interface 116 using New Radio (NR).

In an embodiment, the base station 114a and the WTRUs 102a, 102b, 102c may implement multiple radio access technologies. For example, the base station 114a and the WTRUs 102a, 102b, 102c may implement LTE radio access and NR radio access together, for instance using dual connectivity (DC) principles. Thus, the air interface utilized by WTRUs 102a, 102b, 102c may be characterized by multiple types of radio access technologies and/or transmissions sent to/from multiple types of base stations (e.g., an eNB and a gNB).

In an embodiment, the base station 114a and the WTRUs 102a, 102b, 102c may implement radio technologies such as IEEE 802.11 (i.e., Wireless Fidelity (Wi-Fi), IEEE 802.16 (i.e., Worldwide Interoperability for Microwave Access (WiMAX)), CDMA2000, CDMA2000 1×, CDMA2000 EV-DO, Interim Standard 2000 (IS-2000), Interim Standard 95 (IS-95), Interim Standard 856 (IS-856), Global System for Mobile communications (GSM), Enhanced Data rates for GSM Evolution (EDGE), GSM EDGE (GERAN), and the like.

The base station 114b in FIG. 1A may be a wireless router, Home Node-B, Home eNode-B, or access point, for example, and may utilize any suitable RAT for facilitating wireless connectivity in a localized area, such as a place of business, a home, a vehicle, a campus, an industrial facility, an air corridor (e.g., for use by drones), a roadway, and the like. In an embodiment, the base station 114b and the WTRUs 102c, 102d may implement a radio technology such as IEEE 802.11 to establish a wireless local area network (WLAN). In an embodiment, the base station 114b and the WTRUs 102c, 102d may implement a radio technology such as IEEE 802.15 to establish a wireless personal area network (WPAN). In an embodiment, the base station 114b and the WTRUs 102c, 102d may utilize a cellular-based RAT (e.g., WCDMA, CDMA2000, GSM, LTE, LTE-A, LTE-A Pro, NR, etc.) to establish any of a small cell, picocell or femtocell. As shown in FIG. 1A, the base station 114b may have a direct connection to the Internet 110. Thus, the base station 114b may not be required to access the Internet 110 via the CN 106/115.

The RAN 104/113 may be in communication with the CN 106/115, which may be any type of network configured to provide voice, data, applications, and/or voice over internet protocol (VOIP) services to one or more of the WTRUs 102a, 102b, 102c, 102d. The data may have varying quality of service (QoS) requirements, such as differing throughput requirements, latency requirements, error tolerance requirements, reliability requirements, data throughput requirements, mobility requirements, and the like. The CN 106/115 may provide call control, billing services, mobile location-based services, pre-paid calling, Internet connectivity, video distribution, etc., and/or perform high-level security functions, such as user authentication. Although not shown in FIG. 1A, it will be appreciated that the RAN 104/113 and/or the CN 106/115 may be in direct or indirect communication with other RANs that employ the same RAT as the RAN 104/113 or a different RAT. For example, in addition to being connected to the RAN 104/113, which may be utilizing an NR radio technology, the CN 106/115 may also be in communication with another RAN (not shown) employing any of a GSM, UMTS, CDMA 2000, WiMAX, E-UTRA, or Wi-Fi radio technology.

The CN 106/115 may also serve as a gateway for the WTRUs 102a, 102b, 102c, 102d to access the PSTN 108, the Internet 110, and/or other networks 112. The PSTN 108 may include circuit-switched telephone networks that provide plain old telephone service (POTS). The Internet 110 may include a global system of interconnected computer networks and devices that use common communication protocols, such as the transmission control protocol (TCP), user datagram protocol (UDP) and/or the internet protocol (IP) in the TCP/IP internet protocol suite. The networks 112 may include wired and/or wireless communications networks owned and/or operated by other service providers. For example, the networks 112 may include another CN connected to one or more RANs, which may employ the same RAT as the RAN 104/114 or a different RAT.

Some or all of the WTRUs 102a, 102b, 102c, 102d in the communications system 100 may include multi-mode capabilities (e.g., the WTRUs 102a, 102b, 102c, 102d may include multiple transceivers for communicating with different wireless networks over different wireless links). For example, the WTRU 102c shown in FIG. 1A may be configured to communicate with the base station 114a, which may employ a cellular-based radio technology, and with the base station 114b, which may employ an IEEE 802 radio technology.

FIG. 1B is a system diagram illustrating an example WTRU 102. As shown in FIG. 1B, the WTRU 102 may include a processor 118, a transceiver 120, a transmit/receive element 122, a speaker/microphone 124, a keypad 126, a display/touchpad 128, non-removable memory 130, removable memory 132, a power source 134, a global positioning system (GPS) chipset 136, and/or other elements/peripherals 138, among others. It will be appreciated that the WTRU 102 may include any sub-combination of the foregoing elements while remaining consistent with an embodiment. It will be appreciated that the WTRU 102 may include multiple iterations of any the foregoing elements while remaining consistent with an embodiment.

The processor 118 may be a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs) circuits, any other type of integrated circuit (IC), a state machine, and the like. The processor 118 may perform signal coding, data processing, power control, input/output processing, and/or any other functionality that enables the WTRU 102 to operate in a wireless environment. The processor 118 may be coupled to the transceiver 120, which may be coupled to the transmit/receive element 122. While FIG. 1B depicts the processor 118 and the transceiver 120 as separate components, it will be appreciated that the processor 118 and the transceiver 120 may be integrated together, e.g., in an electronic package or chip.

The transmit/receive element 122 may be configured to transmit signals to, or receive signals from, a base station (e.g., the base station 114a) over the air interface 116. For example, in an embodiment, the transmit/receive element 122 may be an antenna configured to transmit and/or receive RF signals. In an embodiment, the transmit/receive element 122 may be an emitter/detector configured to transmit and/or receive IR, UV, or visible light signals, for example. In an embodiment, the transmit/receive element 122 may be configured to transmit and/or receive both RF and light signals. It will be appreciated that the transmit/receive element 122 may be configured to transmit and/or receive any combination of wireless signals.

As mentioned, although the transmit/receive element 122 is depicted in FIG. 1B as a single element, the WTRU 102 may include any number of transmit/receive elements 122. For example, the WTRU 102 may employ MIMO technology. Thus, in an embodiment, the WTRU 102 may include two or more transmit/receive elements 122 (e.g., multiple antennas) for transmitting and receiving wireless signals over the air interface 116.

The transceiver 120 may be configured to modulate the signals that are to be transmitted by the transmit/receive element 122 and to demodulate the signals that are received by the transmit/receive element 122. As noted above, the WTRU 102 may have multi-mode capabilities. Thus, the transceiver 120 may include multiple transceivers for enabling the WTRU 102 to communicate via multiple RATs, such as NR and IEEE 802.11, for example.

The processor 118 of the WTRU 102 may be coupled to, and may receive user input data from, the speaker/microphone 124, the keypad 126, and/or the display/touchpad 128 (e.g., a liquid crystal display (LCD) display unit or organic light-emitting diode (OLED) display unit). The processor 118 may also output user data to the speaker/microphone 124, the keypad 126, and/or the display/touchpad 128. In addition, the processor 118 may access information from, and store data in, any type of suitable memory, such as the non-removable memory 130 and/or the removable memory 132. The non-removable memory 130 may include random-access memory (RAM), read-only memory (ROM), a hard disk, or any other type of memory storage device. The removable memory 132 may include a subscriber identity module (SIM) card, a memory stick, a secure digital (SD) memory card, and the like. In other embodiments, the processor 118 may access information from, and store data in, memory that is not physically located on the WTRU 102, such as on a server or a home computer (not shown).

The processor 118 may receive power from the power source 134, and may be configured to distribute and/or control the power to the other components in the WTRU 102. The power source 134 may be any suitable device for powering the WTRU 102. For example, the power source 134 may include one or more dry cell batteries (e.g., nickel-cadmium (NiCd), nickel-zinc (NiZn), nickel metal hydride (NiMH), lithium-ion (Li-ion), etc.), solar cells, fuel cells, and the like.

The processor 118 may also be coupled to the GPS chipset 136, which may be configured to provide location information (e.g., longitude and latitude) regarding the current location of the WTRU 102. In addition to, or in lieu of, the information from the GPS chipset 136, the WTRU 102 may receive location information over the air interface 116 from a base station (e.g., base stations 114a, 114b) and/or determine its location based on the timing of the signals being received from two or more nearby base stations. It will be appreciated that the WTRU 102 may acquire location information by way of any suitable location-determination method while remaining consistent with an embodiment.

The processor 118 may further be coupled to other elements/peripherals 138, which may include one or more software and/or hardware modules/units that provide additional features, functionality and/or wired or wireless connectivity. For example, the elements/peripherals 138 may include an accelerometer, an e-compass, a satellite transceiver, a digital camera (e.g., for photographs and/or video), a universal serial bus (USB) port, a vibration device, a television transceiver, a hands free headset, a Bluetooth® module, a frequency modulated (FM) radio unit, a digital music player, a media player, a video game player module, an Internet browser, a virtual reality and/or augmented reality (VR/AR) device, an activity tracker, and the like. The elements/peripherals 138 may include one or more sensors, the sensors may be one or more of a gyroscope, an accelerometer, a hall effect sensor, a magnetometer, an orientation sensor, a proximity sensor, a temperature sensor, a time sensor; a geolocation sensor; an altimeter, a light sensor, a touch sensor, a magnetometer, a barometer, a gesture sensor, a biometric sensor, and/or a humidity sensor.

The WTRU 102 may include a full duplex radio for which transmission and reception of some or all of the signals (e.g., associated with particular subframes for both the uplink (e.g., for transmission) and downlink (e.g., for reception) may be concurrent and/or simultaneous. The full duplex radio may include an interference management unit to reduce and/or substantially eliminate self-interference via either hardware (e.g., a choke) or signal processing via a processor (e.g., a separate processor (not shown) or via processor 118). In an embodiment, the WTRU 102 may include a half-duplex radio for which transmission and reception of some or all of the signals (e.g., associated with particular subframes for either the uplink (e.g., for transmission) or the downlink (e.g., for reception)).

FIG. 1C is a system diagram illustrating the RAN 104 and the CN 106 according to an embodiment. As noted above, the RAN 104 may employ an E-UTRA radio technology to communicate with the WTRUs 102a, 102b, and 102c over the air interface 116. The RAN 104 may also be in communication with the CN 106.

The RAN 104 may include eNode-Bs 160a, 160b, 160c, though it will be appreciated that the RAN 104 may include any number of eNode-Bs while remaining consistent with an embodiment. The eNode-Bs 160a, 160b, 160c may each include one or more transceivers for communicating with the WTRUs 102a, 102b, 102c over the air interface 116. In an embodiment, the eNode-Bs 160a, 160b, 160c may implement MIMO technology. Thus, the eNode-B 160a, for example, may use multiple antennas to transmit wireless signals to, and receive wireless signals from, the WTRU 102a.

Each of the eNode-Bs 160a, 160b, and 160c may be associated with a particular cell (not shown) and may be configured to handle radio resource management decisions, handover decisions, scheduling of users in the uplink (UL) and/or downlink (DL), and the like. As shown in FIG. 1C, the eNode-Bs 160a, 160b, 160c may communicate with one another over an X2 interface.

The CN 106 shown in FIG. 1C may include a mobility management entity (MME) 162, a serving gateway (SGW) 164, and a packet data network (PDN) gateway (PGW) 166. While each of the foregoing elements are depicted as part of the CN 106, it will be appreciated that any one of these elements may be owned and/or operated by an entity other than the CN operator.

The MME 162 may be connected to each of the eNode-Bs 160a, 160b, and 160c in the RAN 104 via an S1 interface and may serve as a control node. For example, the MME 162 may be responsible for authenticating users of the WTRUs 102a, 102b, 102c, bearer activation/deactivation, selecting a particular serving gateway during an initial attach of the WTRUs 102a, 102b, 102c, and the like. The MME 162 may provide a control plane function for switching between the RAN 104 and other RANs (not shown) that employ other radio technologies, such as GSM and/or WCDMA.

The SGW 164 may be connected to each of the eNode-Bs 160a, 160b, 160c in the RAN 104 via the S1 interface. The SGW 164 may generally route and forward user data packets to/from the WTRUs 102a, 102b, 102c. The SGW 164 may perform other functions, such as anchoring user planes during inter-eNode-B handovers, triggering paging when DL data is available for the WTRUs 102a, 102b, 102c, managing and storing contexts of the WTRUs 102a, 102b, 102c, and the like.

The SGW 164 may be connected to the PGW 166, which may provide the WTRUs 102a, 102b, 102c with access to packet-switched networks, such as the Internet 110, to facilitate communications between the WTRUs 102a, 102b, 102c and IP-enabled devices.

The CN 106 may facilitate communications with other networks. For example, the CN 106 may provide the WTRUs 102a, 102b, 102c with access to circuit-switched networks, such as the PSTN 108, to facilitate communications between the WTRUs 102a, 102b, 102c and traditional land-line communications devices. For example, the CN 106 may include, or may communicate with, an IP gateway (e.g., an IP multimedia subsystem (IMS) server) that serves as an interface between the CN 106 and the PSTN 108. In addition, the CN 106 may provide the WTRUs 102a, 102b, 102c with access to the other networks 112, which may include other wired and/or wireless networks that are owned and/or operated by other service providers.

Although the WTRU is described in FIGS. 1A-1D as a wireless terminal, it is contemplated that in certain representative embodiments that such a terminal may use (e.g., temporarily or permanently) wired communication interfaces with the communication network. In representative embodiments, the other network 112 may be a WLAN.

A WLAN in infrastructure basic service set (BSS) mode may have an access point (AP) for the BSS and one or more stations (STAs) associated with the AP. The AP may have an access or an interface to a distribution system (DS) or another type of wired/wireless network that carries traffic into and/or out of the BSS. Traffic to STAs that originates from outside the BSS may arrive through the AP and may be delivered to the STAs. Traffic originating from STAs to destinations outside the BSS may be sent to the AP to be delivered to respective destinations. Traffic between STAs within the BSS may be sent through the AP, for example, where the source STA may send traffic to the AP and the AP may deliver the traffic to the destination STA. The traffic between STAs within a BSS may be considered and/or referred to as peer-to-peer traffic. The peer-to-peer traffic may be sent between (e.g., directly between) the source and destination STAs with a direct link setup (DLS). In certain representative embodiments, the DLS may use an 802.11e DLS or an 802.11z tunneled DLS (TDLS). A WLAN using an Independent BSS (IBSS) mode may not have an AP, and the STAs (e.g., all of the STAs) within or using the IBSS may communicate directly with each other. The IBSS mode of communication may sometimes be referred to herein as an “ad-hoc” mode of communication.

When using the 802.11ac infrastructure mode of operation or a similar mode of operations, the AP may transmit a beacon on a fixed channel, such as a primary channel. The primary channel may be a fixed width (e.g., 20 MHz wide bandwidth) or a dynamically set width via signaling. The primary channel may be the operating channel of the BSS and may be used by the STAs to establish a connection with the AP. In certain representative embodiments, Carrier sense multiple access with collision avoidance (CSMA/CA) may be implemented, for example in in 802.11 systems. For CSMA/CA, the STAs (e.g., every STA), including the AP, may sense the primary channel. If the primary channel is sensed/detected and/or determined to be busy by a particular STA, the particular STA may back off. One STA (e.g., only one station) may transmit at any given time in a given BSS.

High throughput (HT) STAs may use a 40 MHz wide channel for communication, for example, via a combination of the primary 20 MHz channel with an adjacent or nonadjacent 20 MHz channel to form a 40 MHz wide channel.

Very high throughput (VHT) STAs may support 20 MHz, 40 MHz, 80 MHz, and/or 160 MHz wide channels. The 40 MHz, and/or 80 MHz, channels may be formed by combining contiguous 20 MHz channels. A 160 MHz channel may be formed by combining 8 contiguous 20 MHz channels, or by combining two non-contiguous 80 MHz channels, which may be referred to as an 80+80 configuration. For the 80+80 configuration, the data, after channel encoding, may be passed through a segment parser that may divide the data into two streams. Inverse fast fourier transform (IFFT) processing, and time domain processing, may be done on each stream separately. The streams may be mapped on to the two 80 MHz channels, and the data may be transmitted by a transmitting STA. At the receiver of the receiving STA, the above-described operation for the 80+80 configuration may be reversed, and the combined data may be sent to a medium access control (MAC) layer, entity, etc.

Sub 1 GHz modes of operation are supported by 802.11af and 802.11ah. The channel operating bandwidths, and carriers, are reduced in 802.11af and 802.11ah relative to those used in 802.11n, and 802.11ac. 802.11af supports 5 MHz, 10 MHz and 20 MHz bandwidths in the TV white space (TVWS) spectrum, and 802.11ah supports 1 MHz, 2 MHz, 4 MHz, 8 MHz, and 16 MHz bandwidths using non-TVWS spectrum. According to a representative embodiment, 802.11ah may support meter type control/machine-type communications (MTC), such as MTC devices in a macro coverage area. MTC devices may have certain capabilities, for example, limited capabilities including support for (e.g., only support for) certain and/or limited bandwidths. The MTC devices may include a battery with a battery life above a threshold (e.g., to maintain a very long battery life).

WLAN systems, which may support multiple channels, and channel bandwidths, such as 802.11n, 802.11ac, 802.11af, and 802.11ah, include a channel which may be designated as the primary channel. The primary channel may have a bandwidth equal to the largest common operating bandwidth supported by all STAs in the BSS. The bandwidth of the primary channel may be set and/or limited by a STA, from among all STAs in operating in a BSS, which supports the smallest bandwidth operating mode. In the example of 802.11ah, the primary channel may be 1 MHz wide for STAs (e.g., MTC type devices) that support (e.g., only support) a 1 MHz mode, even if the AP, and other STAs in the BSS support 2 MHz, 4 MHz, 8 MHz, 16 MHz, and/or other channel bandwidth operating modes. Carrier sensing and/or network allocation vector (NAV) settings may depend on the status of the primary channel. If the primary channel is busy, for example, due to a STA (which supports only a 1 MHz operating mode), transmitting to the AP, the entire available frequency bands may be considered busy even though a majority of the frequency bands remains idle and may be available.

In the United States, the available frequency bands, which may be used by 802.11ah, are from 902 MHz to 928 MHz. In Korea, the available frequency bands are from 917.5 MHz to 923.5 MHz. In Japan, the available frequency bands are from 916.5 MHz to 927.5 MHz. The total bandwidth available for 802.11ah is 6 MHz to 26 MHz depending on the country code.

FIG. 1D is a system diagram illustrating the RAN 113 and the CN 115 according to an embodiment. As noted above, the RAN 113 may employ an NR radio technology to communicate with the WTRUs 102a, 102b, 102c over the air interface 116. The RAN 113 may also be in communication with the CN 115.

The RAN 113 may include gNBs 180a, 180b, 180c, though it will be appreciated that the RAN 113 may include any number of gNBs while remaining consistent with an embodiment. The gNBs 180a, 180b, 180c may each include one or more transceivers for communicating with the WTRUs 102a, 102b, 102c over the air interface 116. In an embodiment, the gNBs 180a, 180b, 180c may implement MIMO technology. For example, gNBs 180a, 180b may utilize beamforming to transmit signals to and/or receive signals from the WTRUs 102a, 102b, 102c. Thus, the gNB 180a, for example, may use multiple antennas to transmit wireless signals to, and/or receive wireless signals from, the WTRU 102a. In an embodiment, the gNBs 180a, 180b, 180c may implement carrier aggregation technology. For example, the gNB 180a may transmit multiple component carriers to the WTRU 102a (not shown). A subset of these component carriers may be on unlicensed spectrum while the remaining component carriers may be on licensed spectrum. In an embodiment, the gNBs 180a, 180b, 180c may implement Coordinated Multi-Point (COMP) technology. For example, WTRU 102a may receive coordinated transmissions from gNB 180a and gNB 180b (and/or gNB 180c).

The WTRUs 102a, 102b, 102c may communicate with gNBs 180a, 180b, 180c using transmissions associated with a scalable numerology. For example, OFDM symbol spacing and/or OFDM subcarrier spacing may vary for different transmissions, different cells, and/or different portions of the wireless transmission spectrum. The WTRUs 102a, 102b, 102c may communicate with gNBs 180a, 180b, 180c using subframe or transmission time intervals (TTIs) of various or scalable lengths (e.g., including a varying number of OFDM symbols and/or lasting varying lengths of absolute time).

The gNBs 180a, 180b, 180c may be configured to communicate with the WTRUs 102a, 102b, 102c in a standalone configuration and/or a non-standalone configuration. In the standalone configuration, WTRUs 102a, 102b, 102c may communicate with gNBs 180a, 180b, 180c without also accessing other RANs (e.g., such as eNode-Bs 160a, 160b, 160c). In the standalone configuration, WTRUs 102a, 102b, 102c may utilize one or more of gNBs 180a, 180b, 180c as a mobility anchor point. In the standalone configuration, WTRUs 102a, 102b, 102c may communicate with gNBs 180a, 180b, 180c using signals in an unlicensed band. In a non-standalone configuration WTRUs 102a, 102b, 102c may communicate with/connect to gNBs 180a, 180b, 180c while also communicating with/connecting to another RAN such as eNode-Bs 160a, 160b, 160c. For example, WTRUs 102a, 102b, 102c may implement DC principles to communicate with one or more gNBs 180a, 180b, 180c and one or more eNode-Bs 160a, 160b, 160c substantially simultaneously. In the non-standalone configuration, eNode-Bs 160a, 160b, 160c may serve as a mobility anchor for WTRUs 102a, 102b, 102c and gNBs 180a, 180b, 180c may provide additional coverage and/or throughput for servicing WTRUs 102a, 102b, 102c.

Each of the gNBs 180a, 180b, 180c may be associated with a particular cell (not shown) and may be configured to handle radio resource management decisions, handover decisions, scheduling of users in the UL and/or DL, support of network slicing, dual connectivity, interworking between NR and E-UTRA, routing of user plane data towards user plane functions (UPFs) 184a, 184b, routing of control plane information towards access and mobility management functions (AMFs) 182a, 182b, and the like. As shown in FIG. 1D, the gNBs 180a, 180b, 180c may communicate with one another over an Xn interface.

The CN 115 shown in FIG. 1D may include at least one AMF 182a, 182b, at least one UPF 184a, 184b, at least one session management function (SMF) 183a, 183b, and at least one Data Network (DN) 185a, 185b. While each of the foregoing elements are depicted as part of the CN 115, it will be appreciated that any of these elements may be owned and/or operated by an entity other than the CN operator.

The AMF 182a, 182b may be connected to one or more of the gNBs 180a, 180b, 180c in the RAN 113 via an N2 interface and may serve as a control node. For example, the AMF 182a, 182b may be responsible for authenticating users of the WTRUs 102a, 102b, 102c, support for network slicing (e.g., handling of different protocol data unit (PDU) sessions with different requirements), selecting a particular SMF 183a, 183b, management of the registration area, termination of NAS signaling, mobility management, and the like. Network slicing may be used by the AMF 182a, 182b, e.g., to customize CN support for WTRUs 102a, 102b, 102c based on the types of services being utilized WTRUs 102a, 102b, 102c. For example, different network slices may be established for different use cases such as services relying on ultra-reliable low latency (URLLC) access, services relying on enhanced massive mobile broadband (eMBB) access, services for MTC access, and/or the like. The AMF 162 may provide a control plane function for switching between the RAN 113 and other RANs (not shown) that employ other radio technologies, such as LTE, LTE-A, LTE-A Pro, and/or non-3GPP access technologies such as Wi-Fi.

The SMF 183a, 183b may be connected to an AMF 182a, 182b in the CN 115 via an N11 interface. The SMF 183a, 183b may also be connected to a UPF 184a, 184b in the CN 115 via an N4 interface. The SMF 183a, 183b may select and control the UPF 184a, 184b and configure the routing of traffic through the UPF 184a, 184b. The SMF 183a, 183b may perform other functions, such as managing and allocating UE IP address, managing PDU sessions, controlling policy enforcement and QoS, providing downlink data notifications, and the like. A PDU session type may be IP-based, non-IP based, Ethernet-based, and the like.

The UPF 184a, 184b may be connected to one or more of the gNBs 180a, 180b, 180c in the RAN 113 via an N3 interface, which may provide the WTRUs 102a, 102b, 102c with access to packet-switched networks, such as the Internet 110, e.g., to facilitate communications between the WTRUs 102a, 102b, 102c and IP-enabled devices. The UPF 184, 184b may perform other functions, such as routing and forwarding packets, enforcing user plane policies, supporting multi-homed PDU sessions, handling user plane QoS, buffering downlink packets, providing mobility anchoring, and the like.

The CN 115 may facilitate communications with other networks. For example, the CN 115 may include, or may communicate with, an IP gateway (e.g., an IP multimedia subsystem (IMS) server) that serves as an interface between the CN 115 and the PSTN 108. In addition, the CN 115 may provide the WTRUs 102a, 102b, 102c with access to the other networks 112, which may include other wired and/or wireless networks that are owned and/or operated by other service providers. In an embodiment, the WTRUs 102a, 102b, 102c may be connected to a local Data Network (DN) 185a, 185b through the UPF 184a, 184b via the N3 interface to the UPF 184a, 184b and an N6 interface between the UPF 184a, 184b and the DN 185a, 185b.

In view of FIGS. 1A-1D, and the corresponding description of FIGS. 1A-1D, one or more, or all, of the functions described herein with regard to any of: WTRUs 102a-d, base stations 114a-b, eNode-Bs 160a-c, MME 162, SGW 164, PGW 166, gNBs 180a-c, AMFs 182a-b, UPFs 184a-b, SMFs 183a-b, DNs 185a-b, and/or any other element(s)/device(s) described herein, may be performed by one or more emulation elements/devices (not shown). The emulation devices may be one or more devices configured to emulate one or more, or all, of the functions described herein. For example, the emulation devices may be used to test other devices and/or to simulate network and/or WTRU functions.

The emulation devices may be designed to implement one or more tests of other devices in a lab environment and/or in an operator network environment. For example, the one or more emulation devices may perform the one or more, or all, functions while being fully or partially implemented and/or deployed as part of a wired and/or wireless communication network in order to test other devices within the communication network. The one or more emulation devices may perform the one or more, or all, functions while being temporarily implemented/deployed as part of a wired and/or wireless communication network. The emulation device may be directly coupled to another device for purposes of testing and/or may performing testing using over-the-air wireless communications.

The one or more emulation devices may perform the one or more, including all, functions while not being implemented/deployed as part of a wired and/or wireless communication network. For example, the emulation devices may be utilized in a testing scenario in a testing laboratory and/or a non-deployed (e.g., testing) wired and/or wireless communication network in order to implement testing of one or more components. The one or more emulation devices may be test equipment. Direct RF coupling and/or wireless communications via RF circuitry (e.g., which may include one or more antennas) may be used by the emulation devices to transmit and/or receive data.

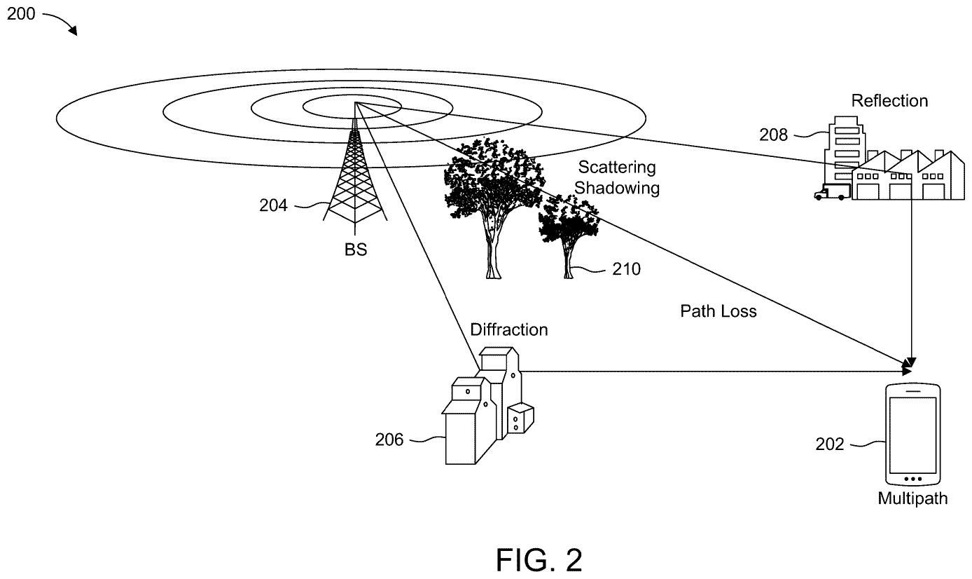

In accordance with one or more embodiments of this disclosure, the devices and systems of FIGS. 1A-1D may be used in connection with devices, systems, and methods for determining configuration information for incremental CSI estimation. For example, the devices and systems of FIGS. 1A-1D may be used in connection with the devices, systems, and methods described in FIGS. 2-10, according to one or more embodiments of this disclosure.

In accordance with one or more embodiments of this disclosure, a reference model of a 5G Network, or other suitable network, is provided as follows.

Without loss of generality, sensing hereinafter refers to the estimation of one or more spatial characteristics such as the absolute or relative position, the 3D orientation, or the speed of one or multiple objects that are not connected to the system under consideration. In some wireless systems, sensing may be considered a usage scenario such as when considering integrated sensing and communications (ISAC). Positioning, in contrast, may refer to the estimation of one or more spatial characteristics of one or multiple devices wirelessly connected to the system under consideration (e.g., a WTRU). It is to be understood that reference to a WTRU may include any one or more suitable WTRUs such as one or more of WTRUs 102a, 102b, 102c, 102d and may be used interchangeably with any of the terms UE, sensing device, or sensing receiver. It is to be understood that a sensing transmitter may be used interchangeably with any of the terms transmit receive point (TRP), base station, or gNB. It is to be understood that reference to a base station may include any one or more suitable base stations such as one or more of base stations 114a or 114b. It is to be understood that reference to a gNB may include any one or more suitable gNBs such as one or more of 180a, 180b, 180c. It will be understood that a wireless network may include any suitable components and devices, including, for example, any of one or more base stations, one or more TRPs, one or more gNBs, one or more WTRUs, any other suitable device or component, or any combination thereof. It will be further understood that a component or device that is part of the wireless network can be referred to as communicating with the wireless network, which may also refer to a wireless network entity, when it is communicating with any one or more other components or devices of the wireless network. For example, reference to a WTRU, which is part of the wireless network, transmitting or receiving signals to or from the wireless network refers to the WTRU transmitting or receiving signals, respectively, to or from any other component or device (e.g., another WTRU) of the wireless network.

FIG. 2 is an example of channel estimation at a WTRU capturing the combined effects of path loss, reflection, and diffraction from a surrounding time-varying environment, according to one or more embodiments of this disclosure. In scenario 200, which includes at least one of a communication, sensing, or position task, WTRU 202 estimates a channel (e.g., channel frequency response (CFR)) between itself and base station 204 for demodulation or detection purposes. It is to be understood that WTRU 202 may be the same as any one of WTRUs 102a, 102b, 102c, or 102d. Is it to be understood that reference to a WTRU herein may include any one or more suitable WTRUs 102a, 102b, 102c, 102d, or 202. It is to be understood that base station 204 may be the same as any one of base stations 114a or 114b. Is it to be understood that reference to base station herein may include any one or more suitable base stations 114a, 114b, or 204. Channel state information (CSI) estimation may face challenges when dealing with doubly dispersive channels, such as those involving fast moving objects in the presence of multipath, to which the eventual presence of phase noise from transceivers may pose additional time variations to the channel seen by the receiver. In an example, diffraction from building 206 or reflection from building 208 may result in some form of signal attenuation (e.g., path loss). In an example, scattering from trees 210 may also result in some form of signal attenuation (e.g., scattering). Properly capturing channel variations may not be feasible with traditional CFR measurements that only reflect a snapshot of the channel at a given time instant (e.g., the start of the received symbol) and not its time variations. Under high mobility, the channel may vary significantly within the duration of a symbol, and a single CFR may no longer be representative of the channel state.

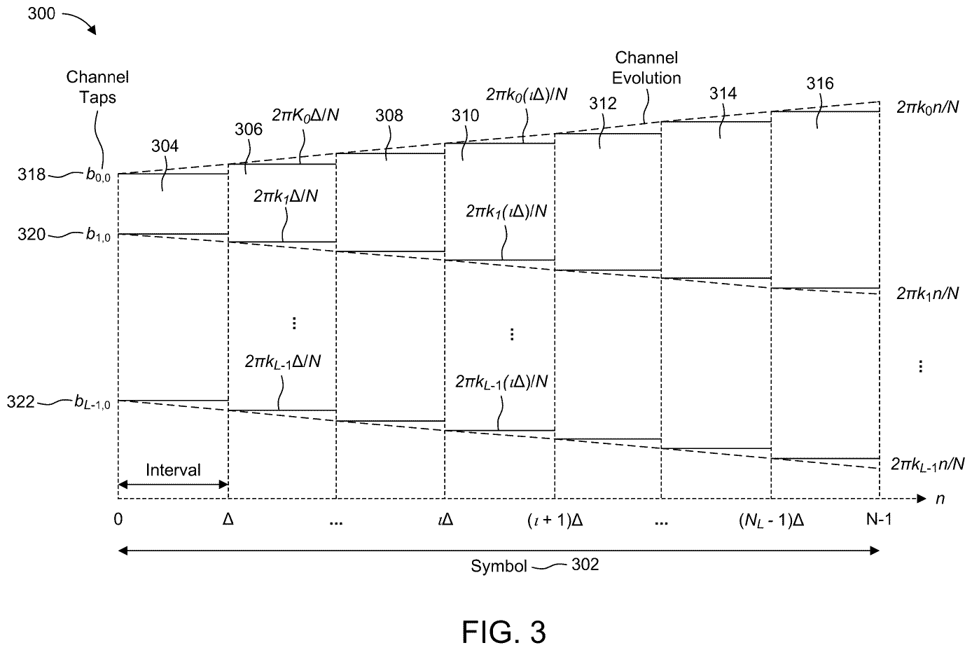

FIG. 3 is a diagram of intra-symbol channel variations being used to derivate a set of piecewise channel transfer functions for equalization, according to one or more embodiments of this disclosure. In diagram 300, symbol 302 is split up into N_{L} sub-symbol intervals of length A whose corresponding CFRs may be individually estimated for each of the sub-symbol intervals. For example, a CFR is estimated specifically for each sub-symbol interval 304, 306, 308, 310, 312, 314, and 316. The time evolution of the channel may thus be expressed by N_{L} sets of L complex values each (one per each sub-symbol interval), denoted by {b_{0,i,Δ}, . . . , b_{L-1,iΔ}, 0≤i<N_{L}}, wherein the time variations of the L taps (e.g., tap 318, 320, 322) may be characterized by, for example, a set of discrete Doppler frequencies {k₀, . . . , k_{L-1}}.

When performing positioning or sensing measurements, the channel impulse response (CIR) may additionally need to be estimated from a suitable RS (e.g., positioning reference signal (PRS) or sounding reference signal for positioning (SRSp)) via correlations. A CIR may characterize the effect of a channel on a transmitted signal, capturing how the signal's amplitude or phase changes as the signal travels through the channel. A CIR may represent the way a channel responds to a signal over time and provides a time-domain representation of the response of a wireless channel to a transmitted signal. A CIR may be used in positioning and sensing tasks (e.g., for line of sight (LOS) or non-line of sight (NLOS) identification) or for performing positioning and sensing measurements. The receiving entity may leverage the CIR to estimate reference signal received power per path (RSRPP), reference signal carrier phase (RSCP), time of arrival (ToA), time difference of arrival (TDoA), angle of arrival (AoA) or other metrics at the relevant MPC peaks. The RS may exhibit correlation properties to yield a spreading gain upon reception, equivalent to a signal-to-noise ratio (SNR) gain, which may be dependent on its length. The RS configuration used in positioning or sensing may impact the achievable accuracy.

A given CFR and a given CIR may be equivalent channel representations at a given time instant because both are related to each other by a Fourier transform. Hence, for CSI estimation purposes, either the CFR or CIR alone may be sufficient to characterize the channel.

RSs, their corresponding measurements, and the CSI estimation techniques used for sensing or positioning, may be different than those used for communications. In addition, traditional CFR measurements may not capture the intra-symbol channel variations in doubly dispersive channels, including phase noise (PN) variations. Traditional CFR measurements may capture only a snapshot of the channel at the intended symbol instant.

Channel variations may distinguish long-term variations (e.g., variations in the channel's macroscopic quantities such as multipath delays, angles of arrival, or average signal powers) and short-term variations (e.g., variations in the channel's microscopic magnitudes such as multipath complex amplitudes, multipath phases, or carrier phase). Both long-term variations and short-term variations may exhibit changes at different timescales. For example, short-term variations occur at timescales comparable with the channel's coherence time, which in some cases may be equal to, or smaller than the symbol duration. Long-term variations may occur at much longer timescales commensurate with the macroscopic variations in the environment (e.g., the geometrical arrangement of scatterers between the transmitter and receiver).

The measurement techniques and the RSs required to measure the long-term and short-term variations of the channel may be different. For example, estimation of the multipath delays in communications may require an RS frequency allocation that at least encompasses a given WTRU's frequency allocation, whereas measurement of the short-term channel variations may require an RS of block-type with contiguous allocation of subcarriers to properly track the multipath complex amplitudes. Techniques used for long-term and short-term CSI estimation by the receiver may be different as well. Similarly, channel estimation techniques and RSs for positioning or sensing may be different when applied to estimate the long-term or the short-term variations.

It is to be understood that reference to incremental CSI estimation refers to the joint estimation of the long-term and short-term channel variations. The optimal techniques and RSs that are needed to enable incremental CSI estimation may not match the techniques and RSs traditionally used for conventional symbol-based channel estimation because of the different timescales, requirements, and RS structures for the estimation of the long-term and short-term channel variations.

In accordance with one or more embodiments of this disclosure, RS configurations for incremental CSI estimation may be WTRU-assisted. In certain representative embodiments, a WTRU capable of receiving reference signals (RS) for channel estimation may be configured by a wireless network, which may be otherwise referred to as a network herein, with parameters for measurement and reporting of RS configurations for incremental CSI (e.g., via radio resource control (RRC) configuration, MAC CE, or DCI signaling). The configuration may include a CSI measurement configuration (e.g., RS resources or CSI measurement); triggering conditions for reporting and updating RS configurations for incremental CSI (e.g., a Doppler within a range) and fallback triggers (e.g., a Doppler outside a range); or a reporting configuration. The reporting configuration may further include CSI variation metrics (e.g., the multipath absolute/relative amplitude variations in a given duration); target values of the multipath delay error, channel estimation error, and maximum CSI variation; long-term CSI magnitudes per sub-symbol interval or for the whole symbol (e.g., the multipath delays whose RSRPPs are above a threshold); short-term CSI magnitudes per sub-symbol interval or for the whole symbol (e.g., the multipath amplitudes whose RSRPPs are above a threshold); or available RS configurations for incremental CSI estimation.

In certain representative embodiments, a WTRU may receive an RS for CSI estimation (e.g., a channel state information reference signal (CSI-RS)) and report CSI measurements for a communication (e.g., a CFR), positioning, or sensing task (e.g., a CIR).

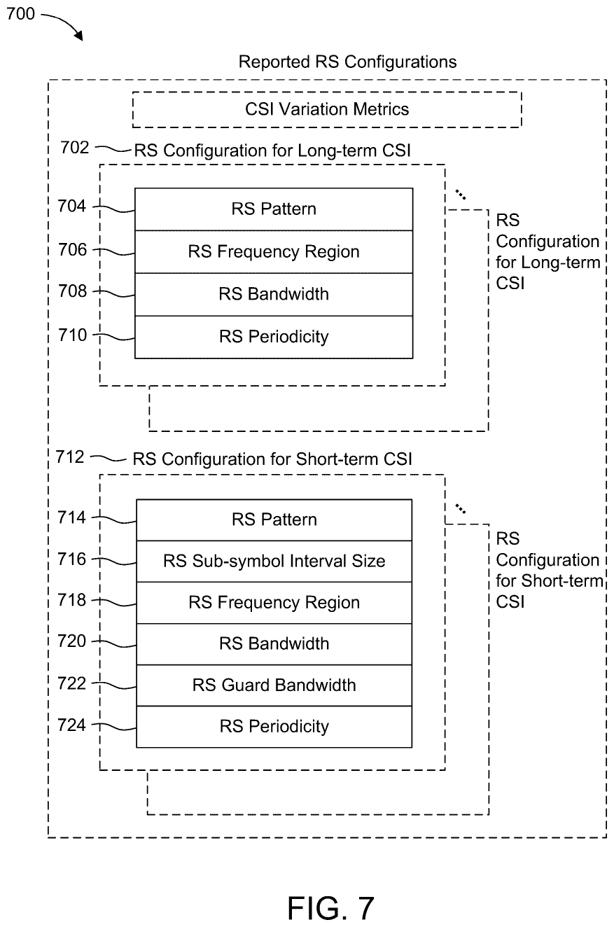

In certain representative embodiments, a WTRU sends to a network a report (e.g., as later referenced in FIG. 7) based on triggering conditions for reporting of RS configurations for incremental CSI. The report may contain CSI variation metrics (e.g., per sub-symbol interval or in a given duration) and their uncertainties, accuracies, or confidence levels. The report may contain one or more RS configurations for long-term CSI estimation, each comprising one or more of the following: an RS pattern for long-term CSI estimation (e.g., of comb-type or block-type); an RS frequency region (e.g., a subcarrier start and end) that encompasses at least the WTRU's allocated resources in a communication task or stays within pre-defined or configured frequency limits (e.g., a bandwidth part, BWP); an RS bandwidth (e.g., in number of resource blocks) based on a delay estimation uncertainty less than or equal to the target value of the delay error; or an RS periodicity (e.g., in number of symbols) based on a difference between the multipath delays at two consecutive RS transmissions less than or equal to the sample duration. The report may contain one or more RS configurations for short-term CSI estimation, each comprising one or more of the following: an RS pattern for short-term CSI estimation (e.g., of block-type); an RS sub-symbol interval size (e.g., in number of samples), or a number of RS sub-symbol intervals, based on a CSI variation metric less than or equal to the maximum CSI variation; an RS frequency region (e.g., a subcarrier start and end) mapped in frequency within the frequency resources configured for incremental CSI estimation; an RS bandwidth (e.g., in number of resource blocks) based on the number of short-term CSI magnitudes to report and the estimation error; an RS guard bandwidth (e.g., in number of subcarriers) greater than or equal to the sum of the experienced Doppler and phase noise spread; or RS periodicity (e.g., in number of symbols) based on the channel's coherence time.

In certain representative embodiments, a WTRU may send an indication to update the contents of the report based on triggering conditions for updating RS configurations for incremental CSI, containing updated values of one or more of the CSI variation metrics, RS configurations for long-term CSI estimation, and RS configurations for short-term CSI estimation.

In certain representative embodiments, a WTRU may send an indication to stop the reporting of RS configurations for incremental CSI based on the configured fallback triggers.

In accordance with one or more embodiments of this disclosure, RS configurations for incremental CSI estimation need not be WTRU-assisted. In certain representative embodiments, a WTRU capable of receiving an RS for channel estimation may be configured (e.g., via RRC configuration, MAC CE, or DCI signaling) with parameters for incremental CSI estimation including: CSI variation metrics (e.g., the multipath absolute/relative amplitude variations in a given duration); one or more available RS configurations, each including one or more of an RS pattern type (e.g., comb/block), an index to a pre-defined set of time/frequency resources, a bandwidth, a duration, or a periodicity; RS sub-symbol interval size (e.g., in number of samples) or a number of RS sub-symbol intervals; RS guard bandwidth (e.g., in number of subcarriers); long-term CSI measurements and short-term CSI measurements to report (e.g., per sub-symbol interval or within a given duration) and their associated RS configurations; correlation or variance measurements associated with any of the long-term or short-term CSI measurements (e.g., a cross-correlation between the short-term CSI magnitudes within a symbol or across symbols); or threshold value of the CSI estimation error, or decoding error, for an RS configuration to be considered suitable for incremental CSI estimation.

In certain representative embodiments, a WTRU receives an RS based on an RS configuration for incremental CSI estimation and performs incremental CSI estimation based on received symbols. The WTRU may perform at least one operation from a variety of operations. In an example, the WTRU obtains the long-term CSI measurements (e.g., a set of multipath delays). In an example, the WTRU transforms a received symbol into a circularly cyclic symbol based on the presence of a ZP field (e.g., by adding the ZP samples to the beginning of the symbol). In an example, the WTRU obtains a first complex vector by removing from the received symbol the frequency contents not reserved for RS or RS guard bandwidth (e.g., using a Fourier transform). In an example, the WTRU obtains a second complex vector by multiplying the first complex vector with a pre-computed matrix associated with the received RS. The precomputed matrix may be a block matrix containing as many sub-matrices as RS sub-symbol intervals and the sub-matrices may contain interpolated samples of the complex modulated symbols in the received RS. In an example, the WTRU estimates a third complex vector that best approximates the second complex vector assuming the multipath delays of the long-term CSI measurement (e.g., such that the norm or energy of the difference between the third and second vectors is a minimum). The third complex vector may be composed of a concatenation of as many sub-vectors as number of RS sub-symbol intervals and the entries of the third complex vector may be zero at positions other than the multipath delays. In an example, the WTRU obtains a CFR per each RS sub-symbol interval from the third complex vector (e.g., by using a Fourier transform of the corresponding sub-vector in the third complex vector).

In certain representative embodiments, a WTRU sends to the network a report (e.g., as later referenced in FIG. 7) with CSI and incremental CSI information. The report may contain at least one of CSI measurements or uncertainties; long-term or short-term CSI measurements or uncertainties; CSI variation metrics (e.g., per sub-symbol interval or in a given duration); correlation or variance measurements associated with any of the long-term or short-term CSI measurements; channel estimation error (e.g., a mean square error (MSE) or normalized mean square error (NMSE) per sub-symbol interval or in a given duration); or an error indication based on one or more RS configurations not suitable for incremental CSI estimation or whose incremental CSI estimation error (e.g., MSE) is above a threshold and the corresponding long/short-term CSI measurements that result after excluding the one or more RS configurations.

It is to be understood that reference to a “UE,” “RX,” “receiver,” or “WTRU” may be used interchangeably to refer to any entity receiving a reference signal. It may be understood that reference to a “transmitter,” “TX,” “TRP,” “gNB,” “BS,” or “WTRU” may be used interchangeably to refer to any entity transmitting a reference signal.

It is to be understood that reference to an “incremental CSI” may refer to a CSI representation comprising a short-term CSI and a long-term CSI measurement. It may be understood that reference to a “short-term CSI” may refer to part of the CSI whose changes occur within timescales comparable to the channel's coherence time (e.g., the multipath complex amplitudes). It may be understood that reference to a “long-term CSI” may refer to part of the CSI whose changes occur over longer timescales than the channel's coherence time (e.g., the multipath delays).

It is to be understood that reference to a “symbol” may refer to a waveform symbol (e.g., an orthogonal frequency division multiplexing (OFDM) symbol) which may contain complex samples of data, pilots, or both modulated in a specific way. It is to be understood that reference to a “sub-symbol interval” may refer to a subset of the symbol duration. It is to be understood that reference to “CSI variation” may refer to a metric of change of CSI measured in a given duration (e.g., a sub-symbol interval).

Without limiting the descriptions herein, solutions are described in the context of a downlink sensing scenario. Solutions may also be applicable to other scenarios as well such as sidelink and uplink.

A cellular scenario may be considered comprising one or more transmitters (e.g., TRPs) and one or more measurement entities, or receivers (e.g., UE, WTRU), both acting as transmitting or receiving entities for communication, positioning or sensing tasks depending on service needs. DL communications, positioning or sensing tasks may involve a WTRU receiving one or more reference signals from one or more transmitting TRPs, performing measurements to derive information about the channel state (e.g., CSI), and reporting the measurements to the network. UL communication, positioning or sensing may involve one or more TRPs receiving signals from one or more transmitting WTRUs and performing CSI estimation to recover the data or locating the WTRU or the target to be sensed.

Sensing tasks may indistinguishably refer to monostatic sensing, bistatic sensing, or multistatic sensing scenarios. In an example, in a bistatic sensing scenario, a sensing transmitter sends reference signals that are captured by a sensing receiver with the goal of determining the location and characteristics of one or more targets in the environment. For example, target characteristics may be one or more of a target position, orientation, velocity, object type (e.g., type “pedestrian” or type “car”), object dimension, or object material. The sensing receiver may also be impacted by reflections or diffractions from clutter (e.g., the ground, a tree) and from other objects (e.g., which may be non-target related) existing in the same environment as the target object. A multistatic sensing scenario may include multiple sensing receivers whose sensing measurements are collected by the network.

A sensing transmitter (e.g., a TRP) may comprise any number of transmit-receive antennas (e.g., in a Massive Multiple Input-Multiple Output (M-MIMO) configuration) with up to N antenna ports for the transmission of sensing signals. WTRUs may be equipped with one or multiple receive antennas.

Without loss of generality, it may be assumed that a suitable RS already exists for a communication, positioning or sensing task. For example, a suitable RS may be a DL positioning reference signal (PRS), a UL sounding reference signal for positioning (SRSp), a demodulation reference signal (DM-RS), a CSI-RS signal in 5G NR, or a dedicated or re-purposed reference signal for sensing.

Descriptions hereinafter may be applicable to any waveform comprising discrete samples that may be analysed by suitable subcarriers in the frequency domain via an application of Discrete Fourier Transforms (DFT) such as cyclic prefix-orthogonal frequency division multiplexing (CP-OFDM), discrete Fourier transform-spread-orthogonal frequency division multiplexing (DFT-s-OFDM), constant envelope-orthogonal frequency division multiplexing (CE-OFDM), frequency modulation-orthogonal frequency division multiplexing (FM-OFDM), or single carrier-frequency domain equalization (SC-FDE), not precluding other waveforms.

In certain representative embodiments, a WTRU may send a capabilities information message to the network including information related to the support of RS configurations for incremental CSI estimation. Information contained in the WTRU capabilities message may include at least one of: support of an RS for incremental CSI estimation; supported CSI variation metrics and an associated time interval for their measurement; supported long-term CSI measurements as one or more of the multipath delays, AoAs, RSRPP, pathloss, Doppler shift, Doppler spread, or Doppler spectrum; supported short-term CSI measurements as one or more of the multipath complex amplitudes, multipath phases, or carrier phases; minimum threshold value of any of the SNR, RSRP, or RSRPP for reporting of long-term and short-term CSI measurements; supported values of the number of sub-symbol intervals (e.g., an integer) or the sub-symbol interval size (e.g., a number of samples or a fraction of the symbol duration); supported RS configurations for long-term and short-term CSI estimation (e.g., RS comb/block patterns, bandwidth, guard bandwidth, or periodicity) as indexes stored in its default configuration/capabilities list; supported RS resources and supported resource partitioning options (e.g., in one or more of a time, frequency, code, or space domains); communication, positioning and sensing processing capabilities (e.g., inverse frequency transform capabilities or maximum number of samples); communication, positioning and sensing frequency ranges; communication, positioning and sensing bandwidth; sensing modes (e.g., monostatic or bistatic); sensing priorities; positioning/sensing spatial resolution; support of CIR estimation for communication, positioning or sensing; support of ToA or TDoA determination and related time resolution for positioning/sensing; support of AoA determination and related AoA resolution for positioning/sensing; support of radar cross section (RCS) determination for sensing; support of RSRPP determination and related power resolution for positioning/sensing; support of carrier phase measurements and related phase resolution for positioning/sensing; sensing Doppler resolution; reflectivity sensitivity (e.g., the minimum power, SNR, or absolute amplitude for the reflections to be detectable by the WTRU); or positioning and sensing related capabilities such as processing capabilities, supported positioning/sensing methods, measurements, error sources, inaccuracies determination, and/or reporting modes. The capabilities message may contain any of the above information related to positioning capabilities, sensing capabilities, communication capabilities, or combinations thereof. The capabilities message may be split in three parts each referring to communication, positioning, and sensing capabilities respectively.

In certain representative embodiments, the WTRU capabilities information message may be used by the network to optimize its allocation of RS configurations for incremental CSI estimation in a communications, positioning, or sensing task.

In certain representative embodiments, a WTRU may send the WTRU capability information message through RRC signaling (e.g., over a physical uplink shared channel such as a physical uplink shared channel (PUSCH)).

In certain representative embodiments, the amount of CSI variation may be ascertained by a WTRU through one or more configuration parameters on CSI variation metrics. In an example, a configuration parameter may be a measurement window to determine the CSI variation (e.g., a sub-symbol interval; a number of symbols, slots, or frames; a time interval; or an index to a list of pre-defined values). In an example, a configuration parameter may be a CSI variation metric such as any one of the following: an absolute or relative change in any of the phase, RSRP, RSRPP, ToA, AoA, or RCS within the measurement window at one or more of the target LOS/MPC components; an absolute or relative change in the position of the WTRU or the objects corresponding to one or more of the target LOS/MPC components within the measurement window; the value of the velocity, Doppler shift, or Doppler spread of the WTRU or the objects corresponding to one or more of the target LOS/MPC components within the measurement window; an absolute or relative change in any of the multipath complex amplitudes characterizing the CIR within the measurement window; or an inter carrier interference (ICI) power incurred by Doppler (e.g., a lower bound or upper bound). In an example, a configuration parameter may be a threshold RSRP, RSRPP or SNR of the LOS/MPC components for measurement of the CSI variation.

In certain representative embodiments, a WTRU may receive information about reference signal resources that may be relevant for measurement and reporting of incremental CSI information. An RS may be used to perform both positioning and sensing. The unification of positioning and sensing tasks for an RS may simplify system design and reduce the overhead associated with managing multiple signals, leading to a more efficient use of resources. From the network side, a node (e.g., a gNB or an LMF) may coordinate the resources for both positioning and sensing. In an example, a WTRU may receive a configuration to perform one or more positioning or sensing tasks (e.g., including an RS configuration and a measurement configuration). Measurement configurations may also include one or more of common measurements used for positioning or sensing, event triggers, triggered actions, assistance information, or thresholds.

In certain representative embodiments, an RS may be used to perform a communication, positioning and sensing task with enough flexibility in its configuration to adapt resources for the needs of each task. Nodes on the network side may coordinate the resources appropriately using, for example, an RS configuration and a measurement configuration. The configurations may include event triggers, triggered actions, assistance information or thresholds.

In certain representative embodiments, an RS may be configured separately for a communication, positioning or sensing task. For example, an RS may be configured such that there is one RS dedicated to communications (e.g., CSI-RS or DM-RS), one RS dedicated to sensing (e.g., a sensing RS), and one RS dedicated to positioning (e.g., PRS or SRSp). Separation allows for the design and optimization of each RS according to its specific requirements, potentially enhancing the accuracy and performance of the individual tasks. From the network side, a node may perform a communication task (e.g., gNB), another node may perform a positioning task (e.g., LMF), and yet another node may perform a sensing task (e.g., gNB or a sensing function) which may require some communication between the nodes involved. In an example, a WTRU may receive distinct configurations to perform communication, positioning and sensing separately, including RS configuration, measurement configuration, event triggers, or triggering actions.

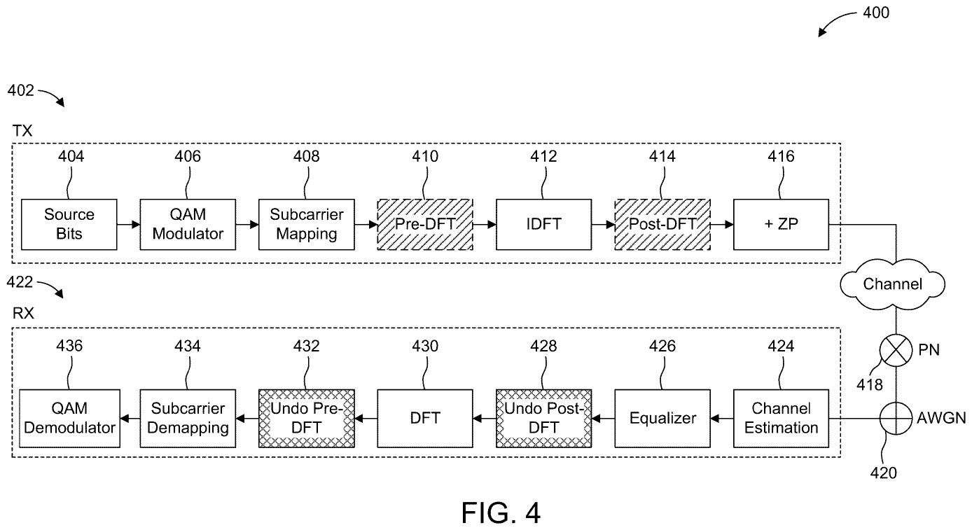

FIG. 4 is a diagram of a generic baseband transceiver architecture for waveforms with FDE capabilities, according to one or more embodiments of this disclosure. An RS may be defined for channel estimation by the receiver in a communication, positioning, or sensing task. In diagram 400, at transceiver 402, source bits at 404 undergo quadrature amplitude (QAM) modulation at 406. Modulated symbols undergo subcarrier mapping at 408, optionally undergo pre-DFT operations 410, and undergo an IDFT at 412. At transceiver 402, further post-DFT operations optionally occur at 414, and zero-padding operations optionally occur at 416. Zero-padding operations may be present in zero-padded waveforms such as zero padding-orthogonal frequency division multiplexing (ZP-OFDM) or frequency modulation-orthogonal frequency division multiplexing (FM-OFDM). After phase noise at 418 and additive white Gaussian noise are added at 420, data at receiver 422 undergoes channel estimation at 424. Data undergoes equalization at 426, optionally undergoes an undoing of post-DFT operations at 428, undergoes a DFT at 430, optionally undergoes an undoing of pre-DFT operations at 432, undergoes subcarrier demapping at 434, and QAM demodulation at 436.

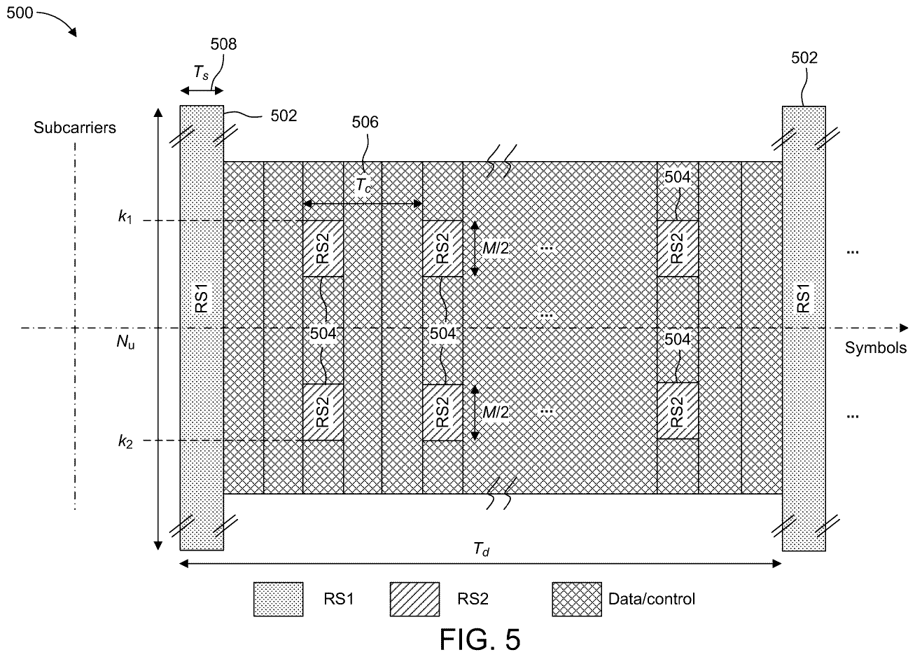

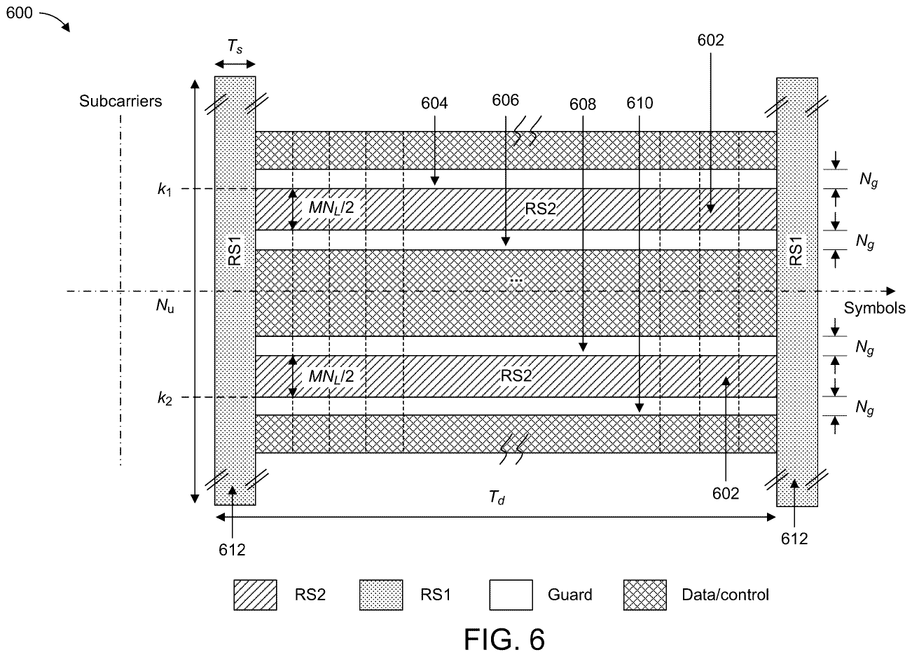

In certain representative embodiments, an RS for incremental CSI estimation may comprise a combination of a first RS, otherwise known as RS1, and a second RS, otherwise known as RS2, both being time interleaved in a periodic way (e.g., as later referenced in FIG. 5 and FIG. 6). The exact structure of the combined RS may depend on the channel mobility through its channel's coherence time T_{c}.

FIG. 5 is a diagram of an RS structure composed of two RS configurations which may be suitable for incremental CSI estimation if the channel's coherence time is longer than a symbol duration, according to one or more embodiments of this disclosure. In diagram 500, RS1 502 and RS2 504 may be suitable for incremental CSI estimation in the case that channel's coherence time T_{c} 506 is longer than the symbol duration Tₛ 508 such that mobility is low to moderate and any impact from phase noise is limited to a common phase error (CPE). RS1 502 configuration may be of comb-type and its bandwidth Bᵤ=NᵤΔf includes Nᵤ subcarriers that may eventually span up to the system's bandwidth. RS1 502 may be suitable to perform periodic estimation of the long-term CSI, for example, the multipath delays, by capturing a snapshot of a CFR. Although RS1 502 may enable full CFR estimation at a given instant, only the long-term CSI information may remain valid until the next occurrence of RS1 502 because the short-term CSI may vary significantly over much shorter timescales. For a velocity v, RS1 502 periodicity T_{d} may be upper bounded by the time needed for a multipath delay to change by one sample due to the tracked object's movement, which may be expressed as

$${T}_{d} \leq \frac{c}{{f}_{s} v} = \frac{{f}_{c}}{{f}_{s}} {T}_{c} . \qquad ( eq . 1 )$$

In certain representative embodiments, RS2 504 configuration may be of block-type to enable estimation of the short-term CSI variations as caused by the channel's fast fading and PN. RS2 504 may span M contiguous subcarriers that may be split in at least two blocks around the direct current (DC) subcarrier, at frequency locations determined by the parameters k₁ and k₂. Splitting in two parts may ensure that the corresponding time-domain signal undergoes wider variations from the higher-order subcarriers involved, which may reduce the estimation uncertainty from the higher value of the second-order derivatives in the Cramer-Rao bound. RS2 504 may comprise only one contiguous portion in the frequency domain above or below the center frequency. Allocating the pilots at an intermediate frequency region between the center and the band edges may be beneficial as a trade-off between the estimation uncertainty and the maximum spectral leakage towards adjacent bands.

In certain representative embodiments, RS2 504 may be regularly sent with a period equal to or shorter than T_{c} 506 to enable tracking of the channel's complex multipath amplitudes under the assumption that the multipath delays are constant and a-priori known, for example, from a previous transmission of RS1 502. The value of M may be dimensioned depending on the maximum MSE incurred by the channel estimation process which may be estimated via simulation for the most typical channel conditions (e.g., tapped- or clustered-delay channels).

FIG. 6 is a diagram of an RS configuration which may be suitable for incremental CSI estimation when the channel's coherence time is comparable to a symbol duration, according to one or more embodiments of this disclosure. In diagram 600, T_{c} is comparable to Tₛ such as when the channel mobility is high or the PN spectral width (e.g., the PN linewidth W_{PN}) is comparable with the subcarrier spacing. The intra-symbol variations of the channel responses may be meaningful, and RS2 602 is allocated for every symbol to be able to track the short-term channel variations. In diagram 600, RS1 612 may also be allocated.

In certain representative embodiments, RS2 602 in high mobility or PN may span a higher number of subcarriers M N_{L} as per the factor N_{L}. N_{L} is the number of sub-symbol intervals that the symbol may be split into to perform incremental CSI estimation. A linear time-variant (LTV) channel may be approximated by a set of N_{L} piecewise linear time-invariant (LTI) channels, each per sub-symbol interval, whose individual CFRs may be estimated with the aid of RS2. N_{L} may be dimensioned from the RMS error incurred by the piecewise approximation, for example, as given by the root of the universal bound for ICI power measured in a sub-symbol interval plus the channel's delay spread,

$$\frac{{T}_{s}}{{N}_{L}} + \frac{1}{{B}_{c}} :$$

$${ε}_{ICI} \leq \frac{π {f}_{D}}{\sqrt{3}} ( \frac{{T}_{s}}{{N}_{L}} + \frac{1}{{B}_{c}} ) , \qquad ( eq . 2 )$$

where fp is the Doppler spread, and B_{c} is the channel's coherence bandwidth.

In certain representative embodiments, to minimize the impact of ICI from adjacent data/control signals caused by Doppler and PN, four RS guard bands (e.g., any one of guard bands 604, 606, 608, 610) may be reserved in frequency with N_{g} subcarriers each to absorb ICI. The guard bandwidth may be equal to or greater than the total frequency spread caused by Doppler and PN, as given by:

$${N}_{g} \geq ⌈ \frac{{f}_{D} + {W}_{P N}}{S C S} ⌉ , \qquad ( eq . 3 )$$

where SCS=1/Tₛ is the subcarrier spacing. It need not be possible to frequency-multiplex RS2 602 with other data or control subcarriers in the same symbol, for example, when the waveform has a wide bandwidth or poor spectral confinement. In such cases, RS2 602 may need to be superimposed with some of the subcarriers of the signal waveform, for example, those whose power level with respect to the maximum is lower than a given threshold, to minimize the impact of RSs superposition. The receiver may need to cancel the interference caused by the superimposed RSs using a successive interference cancelation (SIC) technique that iteratively performs channel estimation, data demodulation, and signal reconstruction.

In certain representative embodiments, the available RS configurations for incremental CSI estimation may be determined by a WTRU according to various types of information provided by the network. In an example, information may be one or more indexes in a discrete set of RS configurations, for example, each characterized by their distinctive parameters in time resources (e.g., number of slots or symbols), frequency resources (e.g., number of subcarriers, or physical resource blocks (PRBs)), code resources (e.g., orthogonal cover codes (OCC)) resources, space resources (e.g., antenna ports), RS comb/block patterns, bandwidth, periodicity, or density. Configurations may be associated with ranges of supported CSI variations for a given CSI variation metric, for example, the variation over time of a multipath complex amplitude, Doppler, RSRPP, ToA, AoA, or RCS. In an example, information may be an RS sub-symbol interval size (e.g., in number of samples) or a number of RS sub-symbol intervals (e.g., an integer or an index). In an example, information may be an RS guard bandwidth (e.g., in number of subcarriers). It is to be understood that reference to RS1 hereafter may refer to either one of RS1 502 or 612, depending on the scenario. It is to be understood that reference to RS2 hereafter may refer to either one of RS2 504 or 602, depending on the scenario.

In certain representative embodiments, the receiver may leverage the presence of RS1 and RS2 configurations to perform incremental CSI estimation for any positioning, sensing, or communication task that requires the CFR or CIR per sub-symbol interval.

In certain representative embodiments, the presence of RS1 in a symbol can be first leveraged by the receiver to obtain the long-term CSI (e.g., the multipath delays) using traditional estimation techniques (e.g., an LS estimation) to estimate, for example, CFR. Since the channel multipath delays may remain applicable until the next transmission of RS1, estimation of the short-term CSI via RS2 may assume full a-priori knowledge of the multipath delays as obtained from RS1. The presence of RS2 may be leveraged by the receiver to estimate a set of piecewise-constant CFRs at each of the configured RS sub-symbol intervals, which represent subsets of the symbol duration where the short-term CSI may be considered constant. The receiver estimates as many sets of complex multipath amplitudes as RS sub-symbol intervals are defined, which depend on the degree of mobility of the channel, and the receiver obtains one CFR per RS sub-symbol interval for equalization. A received signal vector containing RS2 at a given symbol may have the form R∈ [symbol] , where N_{T}=N+N_{CP/ZP} is the symbol length, N is the DFT size, and N_{CP/ZP} is the length of the cyclic prefix (CP) or ZP field. The signal vector may contain RS2 together with other data or control subcarriers that are frequency-multiplexed in the same symbol.

In certain representative embodiments, symbol contents may be digitally filtered to discard the subcarriers not containing RS2. Doing so may depend on whether the time-domain symbol structure contains a CP (e.g., as in CP-OFDM or DFT-s-OFDM) or a ZP (e.g., as in ZP-OFDM or FM-OFDM).

If the symbol contains a CP, filtering out the subcarriers not devoted to RS2 may be done in the frequency domain by nulling them after performing an N-point DFT:

$$\overline{R} = {F}_{N}^{H} Π {F}_{N} R \qquad ( eq . 4 )$$

where F_{N} is the N-size DFT matrix,

$${F}_{N}^{H}$$

is its Hermitian transpose, and the diagonal matrix Π={πⱼₖ}∈ [symbol] may be used to filter out the subcarriers not containing RS2 as follows:

$${π}_{j k} = \{ \begin{matrix}1 , & ( j , k ) ∈ 𝒦 \\ 0 , & otherwise\end{matrix}$$

such that [symbol] is the set of subcarrier indices allocated to RS2.

If the symbol contains a ZP, an overlap-and-add (OLA) operation may be applied to recover the circularity of the symbol by adding the contents of the ZP field to the beginning of the symbol:

$${R}_{O L A} = {R}_{u} + {[ {R}_{l} {0}_{1 \times ( N - {N}_{Z P} )} ]}^{T} ∈ {ℂ}^{N \times 1} , \qquad ( eq . 5 )$$

such that Rᵤ and Rₗ are column vectors containing the upper N rows and the lower N_{ZP} rows of R, respectively. The OLA operation may yield an N-point circular vector whose control/data subcarriers may be nulled prior to channel estimation as in the CP case, to yield a vector:

$$\overline{R} = {F}_{N}^{H} Π {F}_{N} {R}_{O L A} . \qquad ( eq . 6 )$$

If the receiver knows the multipath delays and the length of the CIR L (in samples), for example, from a previous transmission of RS1, a matrix equation may be written as:

$$\overline{R} = {S}_{O L A} B \qquad ( eq . 7 )$$

where B∈ [symbol] is the unknown L-point vector containing the complex tap coefficients at the positions of the a-priori known delays and 0 elsewhere, and the matrices may be defined as follows, with Δ=N/N_{L}:

$${S}_{OLA} = [ \begin{matrix}{V}_{0} & 0 & … & {U}_{0} \\ {U}_{1} & {V}_{1} & ⋮ & ⋮ \\ ⋮ & ⋮ & ⋱ & 0 \\ 0 & … & {U}_{{N}_{L} - 1} & {V}_{{N}_{L} - 1}\end{matrix} ] {v}_{i} = [ \begin{matrix}\text{?} & 0 & … & 0 \\ \text{?} & \text{?} & ⋮ & ⋮ \\ ⋮ & ⋮ & ⋱ & 0 \\ \text{?} & … & \text{?} & \text{?} \\ \text{?} & ⋱ & \text{?} & \text{?} \\ ⋮ & ⋮ & ⋮ & ⋮ \\ \text{?} & … & \text{?} & \text{?}\end{matrix} ] {U}_{i} = [ \begin{matrix}0 & \text{?} & … & \text{?} \\ 0 & 0 & ⋱ & ⋮ \\ ⋮ & ⋮ & ⋮ & \text{?} \\ 0 & … & 0 & 0 \\ ⋮ & ⋮ & ⋮ & ⋮ \\ 0 & … & 0 & 0\end{matrix} ]$$

$$\text{?} \text{indicates text missing or illegible when filed}$$

The terms s₍ₙ₎ in Vᵢ∈ [symbol] are the elements of the N-point time domain signal vector C_{N}=[s₍₀₎ . . . s_{(N-1)}]^{T} constructed from a complex sequence of symbols C in the frequency domain that comprise RS2, by means of an interpolation:

$${C}_{N} = {F}_{N}^{H} vec ( C , {0}_{( N - M {N}_{L} ) \times 1} ) . \qquad ( eq . 8 )$$

The solution to (eq. 7) may be obtained by the complex vector \tilde{B}={\tilde{b}_{i,l}} that satisfies:

$$\tilde{B} = {( {S}_{O L A} )}^{+} \overline{R} \qquad ( eq . 9 )$$

where (S_{OLA})⁺ is the Moore-Penrose pseudo-inverse of S_{OLA}. Calculation of the pseudo-inverse can be done, for example, by solving the optimization problem:

$${\tilde{b}}_{i , l} = arg min \{ {‖ \overline{R} - S \tilde{B} ‖}_{F}^{2} \} \qquad ( eq . 10 )$$

where ∥R̅-S\tilde{B}∥_{F} stands for the Frobenius norm of a vector. This may be challenging if the problem is ill-conditioned, as may happen when the ratio MN_{L}/N is very small. An alternative may be to use a Tikhonov regularization method given by

$${\tilde{b}}_{i , l} = arg min \{ {‖ \overline{R} - S \tilde{B} ‖}_{F}^{2} + {λ}^{2} {‖ B ‖}_{F}^{2} \} , \qquad ( eq . 11 )$$

where λ is the ridge parameter, with a solution

$$\tilde{B} = {( {S}_{O L A}^{H} {S}_{O L A} + {λ}^{2} I )}^{+} \overline{R} . \qquad ( eq . 12 )$$

The solution using (eq. 12) may have an improved condition number depending on the matrix S_{OLA} and the value of λ.

The CFRs of the N_{L} time-invariant channels that approximate the LTV channel may be obtained over a different number of points. If a CP is present, the CFRs may be obtained using \tilde{H}ᵢ=F_{N}vec(\tilde{B}ᵢ, 0_{(N-L)×1}). If a ZP is present, the CFRs may be obtained using \tilde{H}ᵢ=F_{N}_{_{T}}vec(\tilde{B}ᵢ, 0_{(N}_{_{T}}_{-L)×1}).

The normalized mean square error (NMSE) from channel estimation may be given by

$$NMSE = \frac{{‖ \overline{R} - {S}_{O L A} \tilde{B} ‖}_{F}^{2}}{{‖ \overline{R} ‖}_{F}^{2}} . \qquad ( eq . 13 )$$

NMSE may include the combined impact of thermal noise, imperfect channel estimation, and the error incurred by the piecewise approximation of an LTV channel into N_{L} time-invariant channels. NMSE may be used in the design of RS2 to determine an optimum value of M.

In certain representative embodiments, depending on the communication, positioning or sensing task configured by the network, CSI measurements may be reported by a WTRU to a network in addition to incremental CSI measurements. CSI measurements may include various types of information. In an example, CSI measurements may include one or more of the following measurements based on a configured communication task, for example, in compressed mode, uncompressed mode, or as entries in a table: SNR or RSRP of the received signal; CFR measurements characterizing the channel's frequency response (e.g., as a set of complex values each corresponding to a RS subcarrier index or a sub-band comprising a subset of subcarrier indexes); channel quality indicator (CQI) measurements characterizing the channel's quality (e.g., as a wideband CQI value or a set of sub-band CQI values, each corresponding to a different sub-band, or subset of subcarrier indexes); or CIR measurements characterizing the channel's impulse response reported in different report modes such as in a compressed (e.g., as in NR mode 1) or an uncompressed (e.g., as in NR mode 2) form as a set of sample values in a pre-defined or configured digital format. In an example, CSI measurements may include one or more of the following measurements based on a configured positioning or sensing task in compressed mode, uncompressed mode, or as entries in a table: one or more scatterer IDs (e.g., a number or a pre-defined label referring to specific peaks in the CIR); one or more MPC numbers in the CIR; SNR or RSRPP of the measured LOS/MPC components such that measurements may be averaged over a specified or pre-determined time window given as a start and end time (e.g., in terms of symbol index, slot index, frame index, absolute time, or relative time with respect to a reference point) or a duration with respect to a given time instant (e.g., in number of symbols, slots, frames, subframes, or seconds). In WTRU-assisted positioning or sensing, the WTRU may report positioning or sensing measurements (e.g., CIR, ToA, TDoA, AoA, RSRPP, RSCP, Doppler spectrum, or RCS) and their accuracies in a range or a statistical distribution of measured values. A CIR may be reported in different report modes such as in a compressed (e.g., as in NR mode 1) or an uncompressed (e.g., as in NR mode 2) form, for example, as a set of sample values in a pre-defined or configured digital format. If more than one antenna ports are involved, representative ToA and AoA values may be provided by, for example, averaging the magnitudes across the antenna ports. ToAs of MPC components for sensing may be reported relative to the ToA of the corresponding LOS component if present or in addition to it. AoA values may be reported with respect to, for example, the AoA of a configured or a-priori known MPC component obtained from the same or a different RS (e.g., a LoS component or a reflected MPC component from another target) or a WTRU orientation vector (e.g., a vector perpendicular to the receive antenna panel or any other predefined WTRU surface whose coordinates may also be reported and may be expressed as indexes in a table of predefined directions). Measurement accuracies or confidence levels may be given as the variance or uncertainty in the corresponding magnitudes or a percent confidence interval. In WTRU-based positioning or sensing, a WTRU may obtain of an estimated location (e.g., in latitude/longitude or as coordinates in a suitable reference system) of itself or the target, its speed, and the estimated object type in sensing (e.g., a label of type “car,” “pedestrian,” or “bicycle”) with the corresponding accuracies or confidence levels.

Incremental CSI estimation may result in at least one of the following: better tailoring of the RS to the long-term and short-term channel variations; unifying RS design by superseding other RSs potentially designed for channel estimation, phase noise tracking, positioning, and sensing; better coping with high velocity and high PN conditions; or reducing the RS overhead at low to moderate velocity.

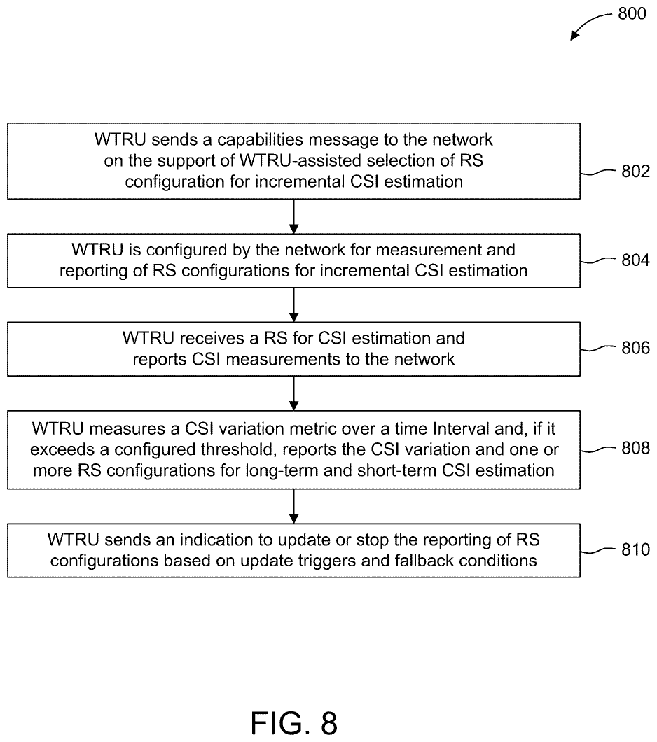

Methods and procedures are described hereinafter for the selection and reporting of RS configurations for incremental CSI estimation assisted by the WTRU in a communication, positioning or sensing task, as later outlined in FIG. 8.

In certain representative embodiments, a WTRU receives and decodes a first network request to provide capabilities information related to the support of WTRU-assisted selection of RS configurations for incremental CSI estimation in communications, positioning or sensing (e.g., as part of 802). The request may be received through RRC signaling. A WTRU may receive and decode this first network request following a random-access procedure. A WTRU may prepare a capabilities information message including information related to the support of RS configurations for incremental CSI estimation. In an example, the WTRU capabilities may include the supported artificial intelligence (AI) models for RS configuration determination for long-term and short-term CSI estimation.

In certain representative embodiments, a WTRU may be configured by the network to report RS configurations for incremental CSI estimation in a communication, positioning or sensing task according to information received from, for example, a control or data channel via RRC configuration, DCI information, or MAC CE signaling (e.g., as part of 804). General parameters for WTRU-assisted selection of RS configurations for incremental CSI estimation may comprise one or more of the following information: the type of communication, positioning, or sensing task according to the service configuration (e.g., a task of type “WTRU data reception,” “WTRU-based positioning,” “WTRU-assisted positioning,” “WTRU-based sensing,” or “WTRU-assisted sensing”); information about the RS resources in time, frequency, code and space for CSI estimation (e.g., CSI-RS or PRS) such as time/frequency allocation, bandwidth, number of symbols, symbol and comb offsets, periodicity, TCI states, antenna ports, OCC codes, or muting patterns; a minimum threshold for CIR peaks to be considered by the WTRU in a communication, positioning or sensing task such as in any of SNR, RSRPP, accuracy (e.g., as an inverse of MSE or NMSE), or correlation with the transmitted signal; a minimum difference between CIR peaks measurements to be considered by the WTRU in a communication, positioning or sensing task such as a delay difference between different CIR measurements above a specific threshold; an indication to perform sensing measurements on a given sensing area (e.g., determined by a range of SNR or RSRPP values) or on one or more target LOS/MPC components specified by any of their MPC number, ToA, AoA, SNR, or RSRPP over a configured or pre-determined time window; assistance information to perform inverse frequency transformations for obtaining CIR responses such as frequency range, bandwidth, frequency layer identifier (e.g., positioning frequency later identifier (PFL-ID)), bandwidth part (e.g., BWP-ID), or number of fast Fourier transform (FFT) samples; spatial relationships between antenna ports for communications, positioning or sensing, for example, including information about the antenna ports that are co-located in a same TRP and beam in the form of configured TCI states with associated QCL characteristics; positioning information expressed, for example, as the ToA of the LOS component for each TRP, AoAs, coordinates of WTRU and TRPs, 3D orientation of WTRU and TRP, LOS likelihoods or WTRU speed; CSI measurements to perform, for example, CFR, CIR, one or more wideband or per-subband CQI; positioning or sensing measurements (e.g., CIR, ToA, TDoA, AoA, absolute or relative RSRPP, RSCP, doppler spectrum, or RCS) to perform; or reference information for positioning or sensing such as one or more of the absolute or relative coordinates and the orientation of the WTRU, TRP, or a reference object. The amount of CSI variation may be determined by the WTRU according to the measurement configuration for determining CSI variation as provided by the network. The available RS configurations for incremental CSI estimation may be determined by the WTRU according to the configuration information provided by the network.

In certain representative embodiments, starting, updating, or terminating the reporting of RS configurations for incremental CSI estimation may include one or more triggering or fallback conditions. In an example, a triggering condition for the reporting of RS configurations may be one or more of the following: one or more of the CSI variation metrics exceeding a threshold or set of thresholds, being inside or outside a range, or being over a configured measurement window; a channel estimation error (e.g., a MSE or NMSE) exceeding a threshold; uncertainty in one or more of the positioning or sensing metrics (e.g., ToA, AoA, SNR, RSRPP, RSCP, a position, or a velocity) of any of the WTRU or sensed targets exceeding a threshold or set of thresholds per each positioning or sensing metric; or an explicit indication to report RS configurations for incremental CSI estimation. In an example, a triggering condition to update the reporting of an RS configuration may be one or more of the following: a change in one or more of the CSI variation metrics exceeding a threshold or set of thresholds, being inside or outside a range, or being over a configured measurement window; a change in the channel estimation error exceeding a threshold; a change in the uncertainty of any of the positioning or sensing metrics exceeding a threshold; a change in the channel conditions (e.g., SNR, RSRP, number of MPC components) exceeding a threshold; a difference between the CSI variation metrics exceeding a threshold or set of thresholds (e.g. a delay difference between different CIR measurements exceeding a threshold); a time elapsed since the last reporting of RS configurations exceeding an absolute or relative duration (e.g., a configured periodicity); a WTRU re-configuration message containing updated configuration parameters for reporting of RS configurations; a change in the detected RS resources (e.g., the birth or death of one or more RS at their configured time-frequency locations or the corresponding antenna ports); a change in the location of the WTRU or one or more objects exceeding a threshold (e.g., the WTRU exiting a preconfigured area of interest); an interference indicator exceeding a threshold (e.g. SNR or signal-to-interference-plus-noise ratio (SINR) in the communications channel exceeding a threshold); or a network request. In an example, a fallback condition to terminate the reporting of RS configurations may be one or more of the following: one or more of the CSI variation metrics being below a threshold or set of thresholds, being inside or outside a range, over a configured measurement window; a channel estimation error being below a threshold; uncertainty in one or more of the positioning or sensing metrics (e.g., ToA, AoA, SNR, RSRPP, RSCP, a position, or a velocity) of any of the WTRU or sensed targets being below a threshold or set of thresholds per each sensing metric; a network request containing an indication from the network to stop reporting of RS configurations and fallback to an RS whose resources are, for example, determined by the configuration or explicitly indicated by their bandwidth, number of symbols, periodicity, TCI states, or antenna ports; a change in the location of the WTRU or one or more objects exceeding a threshold (e.g., the WTRU exiting a preconfigured area of interest); an interference indicator exceeding a specific threshold (e.g. SNR/SINR in the communications channel exceeding a specified threshold); a time elapsed since the last reporting of RS configurations exceeding a maximum absolute or relative duration; or a low battery indication by the WTRU.

In certain representative embodiments, after a WTRU receives a network request for termination of reporting of RS configurations, the resources of an RS for fallback by the WTRU are determined by the configuration of the RS resources for CSI estimation. In an example, the fallback RS resources are explicitly indicated as part of the network request, containing, for example, the bandwidth, time/frequency information, number of symbols, periodicity, TCI states, or antenna ports.

In certain representative embodiments, reporting parameters for WTRU-assisted selection of RS configurations may include of one or more of the following parameters: CSI variation metrics; a target value of the multipath delay error; a target value of the channel estimation error; a maximum value of one or more CSI variation metrics in a given time duration or in a sub-symbol interval; long-term CSI magnitudes such as the multipath delays whose RSRPPs exceed a threshold; short-term CSI magnitudes such as the multipath amplitudes whose RSRPPs exceed a threshold; available RS configurations for incremental CSI estimation; association between long-term CSI and short-term CSI measurements and a set of positioning or sensing metrics such as location, range or velocity; or parameters of one or more a-priori known AI models pre-trained to determine the RS configurations. In an example, a WTRU may receive a reconfiguration message from a network containing updated configuration parameters such as from a control or data channel via RRC configuration, DCI information or MAC CE signaling. A reconfiguration message may include part or all the mentioned reporting parameters for WTRU-assisted selection of RS configurations, and its reception may override part or all of a configuration previously received by the WTRU.

In certain representative embodiments, a WTRU may receive an RS for CSI estimation in a communication, positioning or sensing task per as the configuration, in the form of a synchronization signal burst (SSB), CSI-RS, PRS, or a dedicated RS for sensing (e.g., as part of at least one of 806 or 808). In an example, a WTRU may be configured by the network to measure CSI for a communication task with the configured RS resources by, for example, obtaining CFR at the received symbol. In an example, a WTRU may be configured by the network in a positioning or sensing task to measure at least one of the ToA, TDoA, AoA, absolute or relative RSRPP, RSCP, Doppler spectrum, or RCS with the associated time from the resources.

In certain representative embodiments, a WTRU may perform configured measurements in an allocated measurement time window indicated to the WTRU (e.g., as part of 806). In an example, the time window configuration may consist of at least one of the following: a start or end time of a window (e.g., in terms of symbol index, slot index, frame index, absolute time, or relative time with respect to a reference point); a duration of a window (e.g., in terms of number of symbols, slots, frames, subframes, or seconds); or a periodicity of a window (e.g., in terms of number of symbols, slots, frames, subframes, or seconds).

In certain representative embodiments, a WTRU may receive multiple RSs from one or multiple configured antenna ports for communications, positioning or sensing from, for example, different TRPs or a single TRP (e.g., as part of 806). A WTRU may perform multiple configured measurements at different channel responses obtained from the available TRPs and antenna ports. To accomplish performing multiple configured measurements, a WTRU may perform various actions. In an example, a WTRU obtains channel frequency responses with configured RS resources by, for example, removing known values of the RS complex symbols and performing interpolation of resulting responses over a desired frequency region. In an example, a WTRU obtains the corresponding time-domain CIR responses by, for example, performing inverse frequency transformations to the obtained frequency responses such as by using inverse discrete Fourier transforms. A WTRU may obtain power delay profile (PDP) responses by computing an absolute square magnitude of the CIR responses. In an example, a WTRU obtains the time-domain CIR responses by performing sliding correlations between the received signal and time-shifted versions of the transmitted signal to locate the CIR peaks. In an example, a WTRU stores CIR or PDP peaks whose powers or SNRs exceed a minimum configured RSRPP or SNR threshold or whose peak correlation value between the received signal and the transmitted sensing signal exceeds a threshold. A WTRU may discard all other peaks. In an example, a WTRU stores CIR or PDP peaks that are received within a preconfigured ToA or delay window and discards all other peaks. In an example, a WTRU compares the CIR or PDP responses against a preconfigured CIR or PDP response expressed as a function of time. A WTRU may select the CIR peaks such that the difference between the probability density function of the measured CIR or PDP response and one or more preconfigured CIR or PDP responses are below a preconfigured threshold.

In certain representative embodiments, a WTRU may be configured to perform an inverse frequency transformation of the channel frequency responses based on its capabilities. A WTRU may receive assistance information for performing the inverse frequency transformation. In an example, assistance information from a network may indicate an RS carrier frequency range where a WTRU may perform the inverse frequency transformation. A network may indicate to the WTRU information in terms of one or more of the following: a start frequency and a stop frequency (e.g., in terms of Hz, number of resource elements (REs), or number of resource blocks (RBs)); a frequency offset with respect to an indicated reference frequency (e.g., absolute radio frequency channel number (ARFCN)); a signal bandwidth (e.g., in terms of Hz, number of RBs, or number of REs); a frequency layer identifier (e.g., PFL-ID); or a subset of the carrier bandwidth to be used for sensing (e.g., a BWP-ID). In an example, assistance information may be the number of samples for the frequency transformation (e.g., number of samples for IFFT).

FIG. 7 is an example report from a WTRU which includes different types of information, according to one or more embodiments of this disclosure. The reporting may be part of 808. In an example, report 700 may include one or more CSI variation metrics in the configured measurement window with measurement uncertainties, accuracies or confidence levels. In an example, report 700 may include one or more RS configurations for long-term CSI estimation 702, each including one or more of the following: an RS pattern for long-term CSI estimation (e.g., of comb-type or block-type) 704; an RS frequency region (e.g., expressed as a subcarrier start and end or an index in a table) 706; an RS bandwidth (e.g., expressed as a number of resource blocks, subcarriers, or an index) 708; or an RS periodicity (e.g., expressed as a number of symbols, slots, or a duration) 710. In an example, report 700 may include one or more RS configurations for short-term CSI estimation 712, each comprising one or more of the following: an RS pattern for short-term CSI estimation (e.g., of block-type) 714; RS sub-symbol interval size (e.g., expressed as a number of samples or a fraction of the symbol) 716 or a number of RS sub-symbol intervals (e.g., expressed as an integer); an RS frequency region (e.g., expressed as a subcarrier start and end or an index in a table) 718; an RS bandwidth (e.g., expressed as a number of resource blocks, subcarriers, or an index) 720; an RS guard bandwidth (e.g., expressed as a number of subcarriers) 722; or an RS periodicity (e.g., expressed as a number of symbols, slots, or a duration) 724. It is to be understood that reference to a report herein may be in reference to report 700.

In certain representative embodiments, a WTRU may send a report (e.g., as part of 808 or as referenced in FIG. 7) for the CSI measurements performed on the scheduled RS resources, containing one or more of the following information given in, for example, a compressed mode, uncompressed mode, or as entries in a table: antenna ports used in the measurements; time stamps of the measurements in terms of an absolute or relative time, as a number of slots or frames relative to a known reference; reference signal resources used in the measurements; or CSI reporting measurements. Communication measurements, positioning measurements and sensing measurements performed by the WTRU may be combined in the same report sent to a network. Different reports may be sent separately to the network for the configured communication, positioning and sensing measurements. The one or multiple reports may be transmitted in an uplink control or data channel, such as a PUCCH or PUSCH, and may be conveyed by, for example, an RRC control message, UCI signaling, or MAC CE. Reports may be periodic, aperiodic or semi-persistent in accordance with a WTRU's configuration.

In certain representative embodiments, a WTRU may check conditions for triggering the reporting of RS configurations for incremental CSI estimation (e.g., as part of 808). A WTRU may send to the network a report containing the preferred RS configurations for incremental CSI estimation (e.g., via UCI signaling, MAC CE, or RRC) if conditions for triggering the reporting of RS configurations for incremental CSI estimation are fulfilled. Long-term CSI measurements may involve measurements of multipath delays in a communication task. A WTRU may select an RS configuration for measurement of the long-term CSI such that the configuration encompasses a frequency region covering at least the WTRU's own allocated resources for communications to obtain the multipath delays based on a CFR within, for example, pre-defined or configured frequency limits. A WTRU may select an RS bandwidth such that the delay estimation uncertainty (e.g., a Cramer-Rao bound for the estimated delay) is less than or equal to the target value of the multipath delay error. A WTRU may select an RS periodicity such that the difference between the multipath delays at two consecutive RS transmissions is less than or equal to the sample duration. Short-term CSI measurements may involve measurement of multipath complex amplitudes. A WTRU may select an RS periodicity such that the period between consecutive RS transmissions is less than or equal to the channel's coherence time. A WTRU may select an RS frequency region such that it is contained within the configured resources for incremental CSI estimation. A WTRU may select an RS bandwidth for measurement of the short-term CSI such that the number of subcarriers is less than or equal to the number of multipath amplitudes to be estimated. With reference to FIG. 5 and FIG. 6, the parameter M may be equal to or greater than the number of multipath components to be reported in each sub-symbol interval, denoted by L

$$M \geq L . \qquad ( eq . 14 )$$

In certain representative embodiments, the value of M may be determined from the target value of the channel estimation error such that the channel estimation error is less than or equal to the target value of the channel estimation error.

In certain representative embodiments, a fast turnaround time may be accomplished by using, for example, DCI or MAC CE signaling to report one or more pre-configured RS configurations without explicitly reporting their configuration parameters. In an example, a WTRU may store a set of pre-configured lookup tables capturing what the recommended RS configurations are as a function of M, L, SNR, the signal bandwidth, the channel estimation error, or any other related parameters. A WTRU may perform a selection without resorting to complex calculations of, for example, the Cramer-Rao lower bound (CRLB). A WTRU may also use dynamic signaling based on, for example, DCI or MAC CE to report the recommended configurations with a short turnaround time to prevent channel aging effects. A WTRU may use dynamic signaling to report RS configurations based on, for example, up/down commands issued with reference to a pre-configured lookup table to indicate an RS configuration or configuration parameter immediately above or before a currently used parameter. Signaling may be based on explicit indexes in a pre-configured lookup table. Percentages may be added to the configurations to indicate their relative confidence levels based on current conditions. Recommended RS configurations may contain a usable time duration, for example, in terms of absolute or relative time units or a number of slots, subframes, or frames.

In certain representative embodiments, a WTRU may be configured to report RS configurations for incremental CSI measurements over one or more measurement occasions on an RS for CSI estimation (e.g., as part of at least one of 808 or 810). A WTRU may determine that an indicated RS configuration is outdated or that corresponding measurements are invalidated based on one or more of triggering conditions for reporting an RS configuration update (e.g., as provided by a network as part of the WTRU configuration). Based on determining that an RS configuration is outdated, a WTRU may perform new measurements and send an updated report with the characteristics of the preferred RS configurations in an uplink control or data channel to the network. The report may include various types of information explicitly through, for example, an RRC control message, UCI signaling, or MAC CE. In an example, report information may include updated CSI variation metrics in the configured measurement window and their uncertainties, accuracies or confidence levels. In an example, report information may include one or more updated RS configurations for long-term CSI estimation, each comprising one or more of the following: an RS pattern for long-term CSI estimation (e.g., of comb-type or block-type); an RS frequency region (e.g., expressed as a subcarrier start and end or an index in a table); an RS bandwidth (e.g., expressed as a number of resource blocks, subcarriers, or an index); or an RS periodicity (e.g., expressed as a number of symbols, slots, or a duration). In an example, report information may include one or more updated RS configurations for short-term CSI estimation, each comprising one or more of the following: an RS pattern for short-term CSI estimation (e.g., of block-type); an RS sub-symbol interval size (e.g., expressed as a number of samples or a fraction of the symbol) or a number of RS sub-symbol intervals (e.g., expressed as an integer); an RS frequency region (e.g., expressed as a subcarrier start and end or an index in a table); an RS bandwidth (e.g., expressed as a number of resource blocks, subcarriers, or an index); an RS guard bandwidth (e.g., expressed as a number of subcarriers); or an RS periodicity (e.g., expressed as a number of symbols, slots, or a duration). Dynamic signaling may be used based on up/down commands or explicit indexes in a configured lookup table, for example, with their relative confidence levels to reduce signaling overhead. An updated RS configurations may contain a time duration for suitable use in, for example, absolute or relative time units or a number of slots, subframes, or frames.

In certain representative embodiments, a WTRU may be configured to report RS configurations for incremental CSI estimation over one or more measurement occasions on an RS for CSI estimation (e.g., as part of 810) A WTRU may determine that the indicated RS configurations may be terminated, and that RS configurations for incremental CSI estimation will not be further reported based on any of the fallback conditions to terminate the reporting of RS configurations as provided by the network as part of the WTRU configuration. A WTRU may send a control signaling message to the network containing a termination indication via an uplink control or data channel carrying an RRC message, UCI signaling, or MAC CE when, for example, the termination of the reporting of RS configurations is triggered by the WTRU without an explicit network request.

FIG. 8 is a flowchart outlining WTRU-assisted selection of RS configurations for incremental CSI estimation, according to one or more embodiments of this disclosure. In flowchart 800, at 802, a WTRU sends a capabilities message to a network about support of WTRU assisted selection of RS configurations for incremental CSI estimation. At 804, the WTRU is configured by the network for measurement and reporting an RS configuration for incremental CSI estimation. At 806, the WTRU receives an RS for CSI estimation and reports CSI measurements to the network. At 808, the WTRU measures a CSI variation metric over a time interval and, if the variation metric exceeds a threshold, the WTRU reports the CSI variation and one or more RS configurations for long-term and short-term CSI estimation. At 810, the WTRU sends an indication to update or to stop the reporting of RS configurations based on update trigger or fallback conditions.

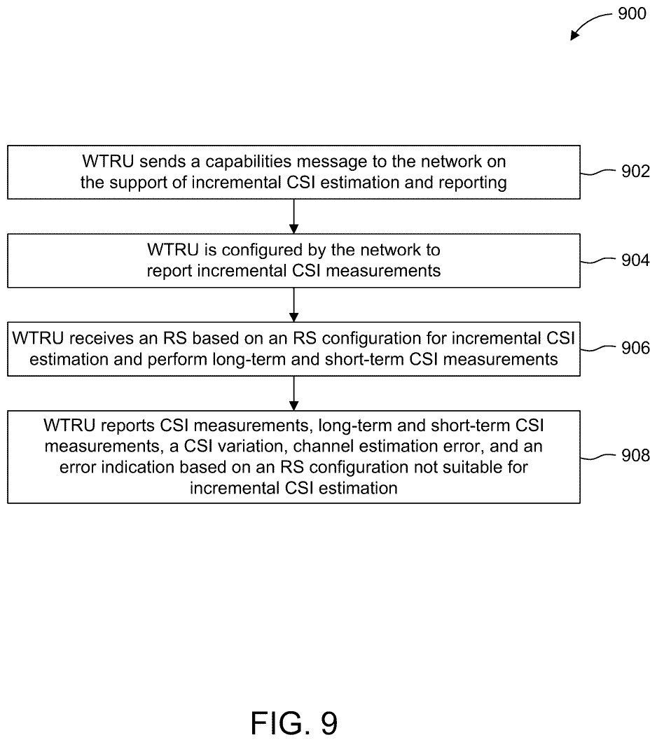

Methods and procedures are described hereinafter for performing and reporting incremental CSI measurements based on RS configurations for incremental CSI estimation, as later outlined in FIG. 9.

In certain representative embodiments, a WTRU may receive and decode a first network request, for example, received through RRC signaling, to provide capabilities information related to the support of incremental CSI estimation and reporting in communications, positioning or sensing (e.g., as part of 902). A WTRU may receive and decode a first network request following the random-access procedure. A WTRU may prepare a capabilities information message including information related to the support of RS configurations for incremental CSI estimation.

In certain representative embodiments, a WTRU may be configured by a network to report incremental CSI measurements in a communication, positioning or sensing task based on various types of information received from, for example, a control or data channel via RRC configuration, DCI information, or MAC CE signaling (e.g., as part of 904).

In certain representative embodiments, a WTRU may receive information including general parameters for the reporting of incremental CSI measurements in a communication, positioning, or sensing task. General parameters for measurement and reporting of incremental CSI measurements may include one or more of the following types of information: the type of communication, positioning, or sensing task according to the service configuration (e.g., a task of type “WTRU data reception,” “WTRU-based positioning,” “WTRU-assisted positioning,” “WTRU-based sensing,” or “WTRU-assisted sensing”); information about the RS resources related to time, frequency, code and space for incremental CSI estimation (e.g., CSI-RS or PRS) such as time/frequency allocation, bandwidth, number of symbols, symbol and comb offsets, periodicity, TCI states, antenna ports, OCC codes, or muting patterns; a minimum threshold for CIR peaks to be considered by the WTRU in a communication, positioning or sensing task as an SNR, RSRPP, accuracy (e.g., as an inverse of MSE or NMSE), or correlation with the transmitted signal; a minimum difference between CIR peaks measurements to be considered by the WTRU in a communication, positioning or sensing task such as a delay difference between different CIR measurements above a specific threshold; an indication to perform sensing measurements on a given sensing area (e.g., determined by a range of SNR or RSRPP values) or on one or more target LOS/MPC components specified by any of their MPC number, ToA, AoA, SNR, or RSRPP over a configured or pre-determined time window; assistance information to perform inverse frequency transformations for obtaining CIR responses such as frequency range, bandwidth, frequency layer identifier (e.g., PFL-ID), bandwidth part (e.g., BWP-ID), or number of FFT samples; spatial relationships between antenna ports for communications, positioning or sensing including, for example, information about the antenna ports that are co-located in a same TRP and beam in the form of configured TCI states with associated QCL characteristics; positioning information expressed, for example, as the ToA of the LOS component for each TRP, AoAs, coordinates of WTRUs and TRPs, 3D orientation of a WTRU and TRP, LOS likelihoods, or WTRU speed; positioning or sensing measurements to perform such as CIR, ToA, TDoA, AoA, absolute or relative RSRPP, RSCP, Doppler spectrum, or RCS; or reference information for positioning or sensing such as one or more of the absolute or relative coordinates and the orientation of the WTRU, TRP, or reference object. A WTRU may determine the amount of CSI variation according to the measurement configuration for determining CSI variation as provided by the network. A WTRU may determine available RS configurations for incremental CSI estimation according to the configuration information provided by the network.

In certain representative embodiments, a WTRU may receive information including reporting parameters for the reporting of incremental CSI measurements in a communication, positioning, or sensing task. Reporting parameters for incremental CSI estimation may include one or more of the following: CSI variation metrics; long-term CSI reporting magnitudes such as the multipath delays whose RSRPPs exceed a threshold; short-term CSI reporting magnitudes such as the multipath amplitudes whose RSRPPs exceed a threshold; whether long-term CSI or short-term CSI reporting magnitudes are reported per each sub-symbol interval or for the whole symbol (e.g., averaged or combined following a-priori known or configured criteria); correlation or variance measurements associated with any of the long or short-term CSI measurements such as a cross-correlation between the reported short-term CSI magnitudes (e.g., within a symbol, across symbols, or within a given interval) or a cross-correlation between the long-term CSI magnitudes across consecutive symbols or within a given interval; association between long-term CSI and short-term CSI measurements with a set of positioning or sensing metrics such as location, range, or velocity; or channel estimation error such as an MSE or NMSE (e.g., per sub-symbol interval or in a given duration).

In certain representative embodiments, a WTRU may be configured by the network to send an error indication on the condition that an RS configuration is not suitable for incremental CSI estimation based on one or more of the following: a long-term CSI measurement in a communication task based on an RS frequency region not encompassing the WTRU's allocated resources for data transmission; a short-term CSI measurement based on a comb-type RS configuration; or a short-term CSI measurement based on an RS bandwidth less than the number of short-term CSI magnitudes to report. A WTRU may be configured by the network with a threshold value of the CSI estimation error (e.g., MSE/NMSE) or the decoding error (e.g., block error rate (BLER)) such that, if exceeded, the WTRU reports the corresponding one or more RS configurations and the performance obtained after excluding the one or more RS configurations. A WTRU may receive a reconfiguration message from the network containing updated configuration parameters from, for example, a control or data channel via RRC configuration, DCI information, or MAC CE signaling. The reconfiguration message may contain some or all the mentioned information part of general or reporting parameters. Reception of the reconfiguration message may override some or all of the configuration information previously received by the WTRU.

In certain representative embodiments, a WTRU may receive from a network (e.g., via DCI signaling, MAC CE, or RRC) RS configuration information for measurement and reporting of incremental CSI (e.g., as part of 906). A WTRU may obtain long-term CSI measurements such as multipath delays based on the configuration. A WTRU may obtain short-term CSI measurements by performing a variety of operations. In an example, a received symbol may contain an appended ZP field at the end of the symbol instead of a CP, making the symbol non-circular. As such, a WTRU may transform the received symbol into a circularly cyclic symbol by, for example, adding the contents of the complex ZP samples to the beginning of the symbol. In an example, a WTRU may obtain a first complex vector by removing from the received symbol the frequency contents not reserved for RS or RS guard bandwidth by, for example, a Fourier transform. The first complex vector may contain only the received RS information as needed to derive incremental CSI information. In an example, a WTRU may obtain a second complex vector by multiplying the first complex vector with a pre-computed matrix associated with the received RS. The pre-computed matrix may be a block matrix containing as many sub-matrices as the configured number of RS sub-symbol intervals whose sub-matrices may contain interpolated samples (e.g., obtained via DFT interpolation) of the complex modulated symbols that are mapped in frequency to the RS. The required interpolation rate may be determined by the ratio between the DFT size and the RS bandwidth for short-term CSI estimation. In an example, a WTRU may estimate a third complex vector that best approximates the second complex vector with a-priori known multipath delays obtained from the long-term CSI measurement. The approximation may be performed by, for example, ensuring that the norm or energy of the difference between the third vector and the second vector is a minimum subject to the constraints of the multipath delays. The third complex vector may include a concatenation of as many sub-vectors as the configured number of RS sub-symbol intervals whose entries may be zero at positions other than the multipath delays. Short-term CSI measurements may include the set of complex multipath amplitudes obtained for each of the RS sub-symbol intervals as contained in the third complex vector. Short-term CSI measurements may include the CIR or CFR per each of the RS sub-symbol intervals by, for example, a Fourier transform of the corresponding sub-vector from the obtained third complex vector. Other short-term CSI measurements may be derived in an analogous manner.

In certain representative embodiments, a WTRU may send a report for the CSI measurements and the incremental CSI measurements performed on the scheduled RS configurations containing various types of information given, for example, in a compressed mode, uncompressed mode, or as entries in a table (e.g., as part of 908). The types of information may be any one of the following: antenna ports used in the measurements; time stamps of the measurements (e.g., in absolute or relative time or as a number of slots or frames relative to a known reference); reference signal resources used in the measurements; CSI reporting measurements; long-term CSI measurements and short-term CSI measurements with their uncertainties; CSI variation metrics; correlation or variance measurements associated with any of the long or short-term CSI measurements such as a cross-correlation between the short-term CSI magnitudes (e.g., within a symbol or across symbols); or channel estimation error (e.g., expressed as an MSE or NMSE).

In certain representative embodiments, a WTRU may send to the network an error indication when the received RS configuration is not suitable for the incremental CSI measurements requested in the configuration. A WTRU may be configured by the network to report any of the transmitted RS configurations whose CSI estimation error or decoding error (e.g., MSE, NMSE, or BLER) exceeds a threshold. A WTRU may perform long-term and short-term CSI measurements on the received RS configurations. If the CSI estimation error exceeds the configured threshold, the WTRU may report to the network an indication of the unexpected low performance of the corresponding RS configuration. A WTRU may also report a suitability value or indicator (e.g., a percentage or a label) expressing the adequacy or inadequacy of the RS configuration and the long-term or short-term CSI measurement requested. A WTRU may report to the network any incremental CSI measurements obtained after excluding the corresponding RS configuration based on, for example, any of the other RS configurations separately or combined in any form.

In certain representative embodiments, the CSI measurements and incremental CSI measurements for communication, positioning, and sensing tasks may be combined in the same report and sent to the network. Different reports may be sent separately to the network for the configured communication, positioning and sensing measurements. The one or multiple reports may be transmitted in an uplink control or data channel (e.g., a PUCCH or PUSCH) and may be conveyed by an RRC control message, UCI signaling, or MAC CE. Reports may be periodic, aperiodic or semi-persistent in accordance with the WTRU's configuration.

FIG. 9 is a flowchart outlining a procedure for incremental CSI estimation and reporting, according to one or more embodiments of this disclosure. At 902, a WTRU sends a capabilities message to the network on support of incremental CSI estimation and reporting. At 904, the WTRU is configured by the network to report incremental CSI measurements. At 906, the WTRU receives an RS based on an RS configuration for incremental CSI estimation and performs long-term and short-term CSI measurements. At 908, the WTRU reports CSI measurements, long-term and short-term CSI measurements, a CSI variation, a channel estimation error, and an error indication based on an RS configuration not suitable for CSI estimation.

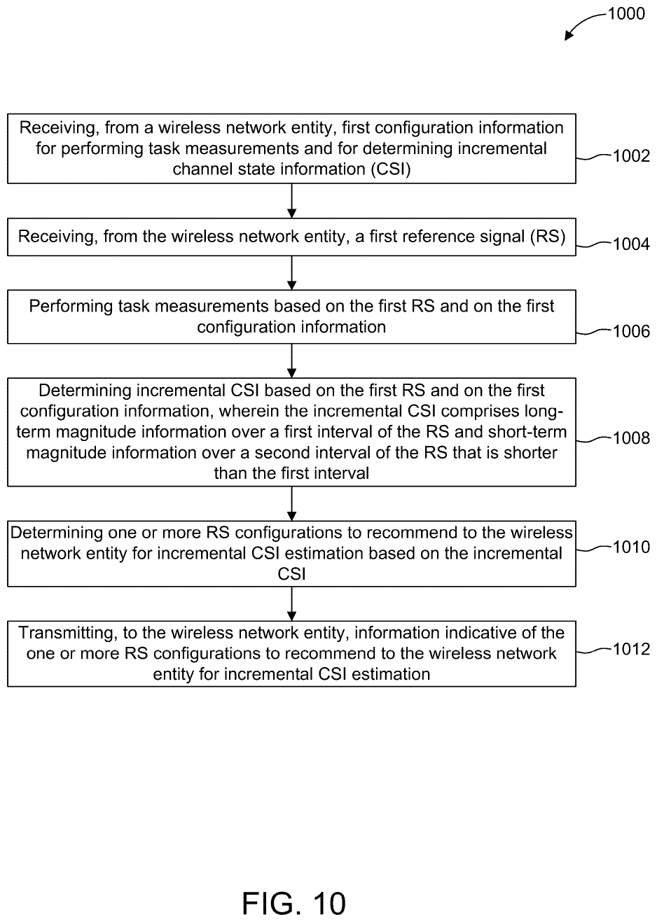

FIG. 10 shows flowchart 1000 of illustrative steps for determining configuration information for incremental CSI estimation, according to one or more embodiments of this disclosure.

At 1002, a WTRU receives, from a wireless network entity, first configuration information for performing task measurements and for determining incremental CSI. Communication with a wireless network entity may be in reference to communication with a base station, gNB, TRP, or any other suitable node in a network. In certain representative embodiments, first configuration information comprises at least one of CSI variation metrics, target values of multipath delay error and channel estimation error, maximum CSI variation, long-term and short-term CSI magnitudes per sub-symbol interval, or available RS configurations for incremental CSI estimation. CSI variation metrics comprise at least one of a change in one or more of a phase, RSRP, RSRPP, ToA, AoA, or RCS within a measurement window of one or more of a target LOS or MPC. Task measurements comprise one or more of sensing measurements, positioning measurements, communication measurements, or incremental CSI measurements. In certain representative embodiments, a WTRU may perform 1002 in conjunction with or in addition to any one of 802-804 or 902-904.

At 1004, a WTRU receives, from the wireless network entity, an RS. In certain representative embodiments, a WTRU may perform 1004 in conjunction with or in addition to any one of 806 or 906.

At 1006, a WTRU performs task measurements based on the first RS and on the first configuration information. In certain representative embodiments, a WTRU may perform 1006 in conjunction with or in addition to any one of 808 or 906.

At 1008, a WTRU determines incremental CSI based on the first RS and on the first configuration information, wherein the incremental CSI comprises long-term magnitude information over a first interval of the RS and short-term magnitude information over a second interval of the RS that is shorter than the first interval. In certain representative embodiments, the first interval comprises a duration over one or more symbol intervals. In certain representative embodiments, the second interval comprises a duration over a subset of a symbol interval. In certain representative embodiments, long-term magnitude information comprises one or more of an RS pattern for long-term CSI estimation, an RS frequency region, an RS bandwidth based on a delay estimation uncertainty, or an RS periodicity based on a difference between multipath delays. In certain representative embodiments, short-term magnitude information comprises at least one of an RS pattern for short-term CSI estimation, an RS sub-symbol interval size, an RS frequency region, an RS bandwidth based on the number of multipaths, an RS guard bandwidth based on Doppler and phase noise spread, or an RS periodicity based on a channel's coherence time. In certain representative embodiments, a WTRU may perform 1008 in conjunction with or in addition to any one of 808 or 906.

At 1010, a WTRU determines one or more RS configurations to recommend to the wireless network entity for incremental CSI estimation based on the incremental CSI. In certain representative embodiments, the WTRU generates a report (e.g., as referenced in FIG. 7) comprising information indicative of the one or more RS configurations to recommend to the wireless network entity for incremental CSI estimation in one of a compressed mode, an uncompressed mode, or entries in a table and transmits, to the wireless network entity, the report. In certain representative embodiments, a WTRU may perform 1010 in conjunction with or in addition to any one of 808 or 908.

At 1012, a WTRU transmits, to the wireless network entity, information indicative of the one or more RS configurations to recommend to the wireless network entity for incremental CSI estimation. In certain representative embodiments, a WTRU determines a fallback condition for transmitting information indicative of the one or more RS configurations to recommend to the wireless network entity for incremental CSI estimation, wherein the fallback condition is based at least in part on a CSI variation metric being below a threshold. Based at least in part on the fallback condition, the WTRU terminates transmission of the information indicative of the one or more RS configurations to recommend to the wireless network entity for incremental CSI estimation. In certain representative embodiments, a WTRU may perform 1006 in conjunction with or in addition to any one of 810 or 908.

Although features and elements are provided above in particular combinations, one of ordinary skill in the art will appreciate that each feature or element can be used alone or in any combination with the other features and elements. The present disclosure is not to be limited in terms of the particular embodiments described in this application, which are intended as illustrations of various aspects. Many modifications and variations may be made without departing from its spirit and scope, as will be apparent to those skilled in the art. No element, act, or instruction used in the description of the present application should be construed as critical or essential to the invention unless explicitly provided as such. Functionally equivalent methods and apparatuses within the scope of the disclosure, in addition to those enumerated herein, will be apparent to those skilled in the art from the foregoing descriptions. Such modifications and variations are intended to fall within the scope of the appended claims. The present disclosure is to be limited only by the terms of the appended claims, along with the full scope of equivalents to which such claims are entitled. It is to be understood that this disclosure is not limited to particular methods or systems.

The foregoing embodiments are discussed, for simplicity, with regard to the terminology and structure of wireless communication capable devices, (e.g., radio wave emitters and receivers). However, the embodiments discussed are not limited to these systems but may be applied to other systems that use other forms of electromagnetic waves or non-electromagnetic waves such as acoustic waves.

It is also to be understood that the terminology used herein is for the purpose of describing particular embodiments only, and is not intended to be limiting. As used herein, the term “video” or the term “imagery” may mean any of a snapshot, single image and/or multiple images displayed over a time basis. As another example, when referred to herein, the terms “user equipment” and its abbreviation “UE”, the term “remote” and/or the terms “head mounted display” or its abbreviation “HMD” may mean or include (i) a wireless transmit and/or receive unit (WTRU); (ii) any of a number of embodiments of a WTRU; (iii) a wireless-capable and/or wired-capable (e.g., tetherable) device configured with, inter alia, some or all structures and functionality of a WTRU; (iii) a wireless-capable and/or wired-capable device configured with less than all structures and functionality of a WTRU; or (iv) the like. Details of an example WTRU, which may be representative of any WTRU recited herein, are provided herein with respect to FIGS. 1A-1D. As another example, various disclosed embodiments herein are described as utilizing a head mounted display. Those skilled in the art will recognize that a device other than the head mounted display may be utilized and some or all of the disclosure and various disclosed embodiments can be modified accordingly without undue experimentation. Examples of such other device may include a drone or other device configured to stream information for providing the adapted reality experience.

In addition, the methods provided herein may be implemented in a computer program, software, or firmware incorporated in a computer-readable medium for execution by a computer or processor. Examples of computer-readable media include electronic signals (transmitted over wired or wireless connections) and computer-readable storage media. Examples of computer-readable storage media include, but are not limited to, a read only memory (ROM), a random access memory (RAM), a register, cache memory, semiconductor memory devices, magnetic media such as internal hard disks and removable disks, magneto-optical media, and optical media such as CD-ROM disks, and digital versatile disks (DVDs). A processor in association with software may be used to implement a radio frequency transceiver for use in a WTRU, UE, terminal, base station, RNC, or any host computer.

Variations of the method, apparatus and system provided above are possible without departing from the scope of the invention. In view of the wide variety of embodiments that can be applied, it should be understood that the illustrated embodiments are examples only, and should not be taken as limiting the scope of the following claims. For instance, the embodiments provided herein include handheld devices, which may include or be utilized with any appropriate voltage source, such as a battery and the like, providing any appropriate voltage.

Moreover, in the embodiments provided above, processing platforms, computing systems, controllers, and other devices that include processors are noted. These devices may include at least one Central Processing Unit (“CPU”) and memory. In accordance with the practices of persons skilled in the art of computer programming, reference to acts and symbolic representations of operations or instructions may be performed by the various CPUs and memories. Such acts and operations or instructions may be referred to as being “executed,” “computer executed” or “CPU executed.”

One of ordinary skill in the art will appreciate that the acts and symbolically represented operations or instructions include the manipulation of electrical signals by the CPU. An electrical system represents data bits that can cause a resulting transformation or reduction of the electrical signals and the maintenance of data bits at memory locations in a memory system to thereby reconfigure or otherwise alter the CPU's operation, as well as other processing of signals. The memory locations where data bits are maintained are physical locations that have particular electrical, magnetic, optical, or organic properties corresponding to or representative of the data bits. It should be understood that the embodiments are not limited to the above-mentioned platforms or CPUs and that other platforms and CPUs may support the provided methods.

The data bits may also be maintained on a computer readable medium including magnetic disks, optical disks, and any other volatile (e.g., Random Access Memory (RAM)) or non-volatile (e.g., Read-Only Memory (ROM)) mass storage system readable by the CPU. The computer readable medium may include cooperating or interconnected computer readable medium, which exist exclusively on the processing system or are distributed among multiple interconnected processing systems that may be local or remote to the processing system. It should be understood that the embodiments are not limited to the above-mentioned memories and that other platforms and memories may support the provided methods.

In an illustrative embodiment, any of the operations, processes, etc. described herein may be implemented as computer-readable instructions stored on a computer-readable medium. The computer-readable instructions may be executed by a processor of a mobile unit, a network element, and/or any other computing device.

There is little distinction left between hardware and software implementations of aspects of systems. The use of hardware or software is generally (but not always, in that in certain contexts the choice between hardware and software may become significant) a design choice representing cost versus efficiency tradeoffs. There may be various vehicles by which processes and/or systems and/or other technologies described herein may be effected (e.g., hardware, software, and/or firmware), and the preferred vehicle may vary with the context in which the processes and/or systems and/or other technologies are deployed. For example, if an implementer determines that speed and accuracy are paramount, the implementer may opt for a mainly hardware and/or firmware vehicle. If flexibility is paramount, the implementer may opt for a mainly software implementation. Alternatively, the implementer may opt for some combination of hardware, software, and/or firmware.

The foregoing detailed description has set forth various embodiments of the devices and/or processes via the use of block diagrams, flowcharts, and/or examples. Insofar as such block diagrams, flowcharts, and/or examples include one or more functions and/or operations, it will be understood by those within the art that each function and/or operation within such block diagrams, flowcharts, or examples may be implemented, individually and/or collectively, by a wide range of hardware, software, firmware, or virtually any combination thereof. In an embodiment, several portions of the subject matter described herein may be implemented via Application Specific Integrated Circuits (ASICs), Field Programmable Gate Arrays (FPGAs), digital signal processors (DSPs), and/or other integrated formats. However, those skilled in the art will recognize that some aspects of the embodiments disclosed herein, in whole or in part, may be equivalently implemented in integrated circuits, as one or more computer programs running on one or more computers (e.g., as one or more programs running on one or more computer systems), as one or more programs running on one or more processors (e.g., as one or more programs running on one or more microprocessors), as firmware, or as virtually any combination thereof, and that designing the circuitry and/or writing the code for the software and/or firmware would be well within the skill of one of skill in the art in light of this disclosure. In addition, those skilled in the art will appreciate that the mechanisms of the subject matter described herein may be distributed as a program product in a variety of forms, and that an illustrative embodiment of the subject matter described herein applies regardless of the particular type of signal bearing medium used to actually carry out the distribution. Examples of a signal bearing medium include, but are not limited to, the following: a recordable type medium such as a floppy disk, a hard disk drive, a CD, a DVD, a digital tape, a computer memory, etc., and a transmission type medium such as a digital and/or an analog communication medium (e.g., a fiber optic cable, a waveguide, a wired communications link, a wireless communication link, etc.).

Those skilled in the art will recognize that it is common within the art to describe devices and/or processes in the fashion set forth herein, and thereafter use engineering practices to integrate such described devices and/or processes into data processing systems. That is, at least a portion of the devices and/or processes described herein may be integrated into a data processing system via a reasonable amount of experimentation. Those having skill in the art will recognize that a typical data processing system may generally include one or more of a system unit housing, a video display device, a memory such as volatile and non-volatile memory, processors such as microprocessors and digital signal processors, computational entities such as operating systems, drivers, graphical user interfaces, and applications programs, one or more interaction devices, such as a touch pad or screen, and/or control systems including feedback loops and control motors (e.g., feedback for sensing position and/or velocity, control motors for moving and/or adjusting components and/or quantities). A typical data processing system may be implemented utilizing any suitable commercially available components, such as those typically found in data computing/communication and/or network computing/communication systems.

The herein described subject matter sometimes illustrates different components included within, or connected with, different other components. It is to be understood that such depicted architectures are merely examples, and that in fact many other architectures may be implemented which achieve the same functionality. In a conceptual sense, any arrangement of components to achieve the same functionality is effectively “associated” such that the desired functionality may be achieved. Hence, any two components herein combined to achieve a particular functionality may be seen as “associated with” each other such that the desired functionality is achieved, irrespective of architectures or intermedial components. Likewise, any two components so associated may also be viewed as being “operably connected”, or “operably coupled”, to each other to achieve the desired functionality, and any two components capable of being so associated may also be viewed as being “operably couplable” to each other to achieve the desired functionality. Specific examples of operably couplable include but are not limited to physically mateable and/or physically interacting components and/or wirelessly interactable and/or wirelessly interacting components and/or logically interacting and/or logically interactable components.

With respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, where only one item is intended, the term “single” or similar language may be used. As an aid to understanding, the following appended claims and/or the descriptions herein may include usage of the introductory phrases “at least one” and “one or more” to introduce claim recitations. However, the use of such phrases should not be construed to imply that the introduction of a claim recitation by the indefinite articles “a” or “an” limits any particular claim including such introduced claim recitation to embodiments including only one such recitation, even when the same claim includes the introductory phrases “one or more” or “at least one” and indefinite articles such as “a” or “an” (e.g., “a” and/or “an” should be interpreted to mean “at least one” or “one or more”). The same holds true for the use of definite articles used to introduce claim recitations. In addition, even if a specific number of an introduced claim recitation is explicitly recited, those skilled in the art will recognize that such recitation should be interpreted to mean at least the recited number (e.g., the bare recitation of “two recitations,” without other modifiers, means at least two recitations, or two or more recitations). Furthermore, in those instances where a convention analogous to “at least one of A, B, and C, etc.” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.). In those instances where a convention analogous to “at least one of A, B, or C, etc.” is used, in general such a construction is intended in the sense one having skill in the art would understand the convention (e.g., “a system having at least one of A, B, or C” would include but not be limited to systems that have A alone, B alone, C alone, A and B together, A and C together, B and C together, and/or A, B, and C together, etc.). It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.” Further, the terms “any of” followed by a listing of a plurality of items and/or a plurality of categories of items, as used herein, are intended to include “any of,” “any combination of,” “any multiple of,” and/or “any combination of multiples of” the items and/or the categories of items, individually or in conjunction with other items and/or other categories of items. Moreover, as used herein, the term “set” is intended to include any number of items, including zero. Additionally, as used herein, the term “number” is intended to include any number, including zero. And the term “multiple”, as used herein, is intended to be synonymous with “a plurality”.

In addition, where features or aspects of the disclosure are described in terms of Markush groups, those skilled in the art will recognize that the disclosure is also thereby described in terms of any individual member or subgroup of members of the Markush group.

As will be understood by one skilled in the art, for any and all purposes, such as in terms of providing a written description, all ranges disclosed herein also encompass any and all possible subranges and combinations of subranges thereof. Any listed range can be easily recognized as sufficiently describing and enabling the same range being broken down into at least equal halves, thirds, quarters, fifths, tenths, etc. As a non-limiting example, each range discussed herein may be readily broken down into a lower third, middle third and upper third, etc. As will also be understood by one skilled in the art all language such as “up to,” “at least,” “greater than,” “less than,” and the like includes the number recited and refers to ranges which can be subsequently broken down into subranges as discussed above. Finally, as will be understood by one skilled in the art, a range includes each individual member. Thus, for example, a group having 1-3 cells refers to groups having 1, 2, or 3 cells. Similarly, a group having 1-5 cells refers to groups having 1, 2, 3, 4, or 5 cells, and so forth.

Moreover, the claims should not be read as limited to the provided order or elements unless stated to that effect. In addition, use of the terms “means for” in any claim is intended to invoke means-plus-function claim format, and any claim without the terms “means for” is not so intended.

What is claimed is:

1. A method performed by a wireless transmit/receive unit (WTRU), the method comprising:
receiving, from a wireless network entity, first configuration information for performing task measurements and for determining incremental channel state information (CSI);
receiving, from the wireless network entity, a first reference signal (RS);
performing task measurements based on 1) the first RS and 2) the first configuration information;
determining incremental CSI based on 1) the first RS and 2) the first configuration information, wherein the incremental CSI comprises:
long-term magnitude information over a first interval of the RS; and
short-term magnitude information over a second interval of the RS that is shorter than the first interval;
determining one or more RS configurations to recommend to the wireless network entity for incremental CSI estimation based on the incremental CSI; and
transmitting, to the wireless network entity, information indicative of the one or more RS configurations to recommend to the wireless network entity for incremental CSI estimation.

2. The method of claim 1, wherein task measurements comprise one or more of sensing measurements, positioning measurements, communication measurements, or incremental CSI measurements.

3. The method of claim 1, wherein the first interval comprises a duration over one or more symbol intervals.

4. The method of claim 1, wherein the second interval comprises a duration over a subset of a symbol interval.

5. The method of claim 1, wherein the first configuration information comprises at least one of CSI variation metrics, target values of multipath delay error and channel estimation error, maximum CSI variation, long-term and short-term CSI magnitudes per sub-symbol interval, or available RS configurations for incremental CSI estimation.

6. The method of claim 5, wherein CSI variation metrics comprise at least one of a change in one or more of a phase, reference signal received power (RSRP), reference signal received power per path (RSRPP), time of arrival (ToA), angle of arrival (AoA), or radar cross section (RCS) within a measurement window of one or more of a target line of sight (LOS) or multipath component (MPC).

7. The method of claim 1, wherein the long-term magnitude information comprises one or more of an RS pattern for long-term CSI estimation, an RS frequency region, an RS bandwidth based on a delay estimation uncertainty, or an RS periodicity based on a difference between multipath delays.

8. The method of claim 1, wherein the short-term magnitude information comprises at least one of an RS pattern for short-term CSI estimation, an RS sub-symbol interval size, an RS frequency region, an RS bandwidth based on the number of multipaths, an RS guard bandwidth based on Doppler and phase noise spread, or an RS periodicity based on a channel's coherence time.

9. The method of claim 1, further comprising:
determining a fallback condition for transmitting information indicative of the one or more RS configurations to recommend to the wireless network entity for incremental CSI estimation, wherein the fallback condition is based at least in part on a CSI variation metric being below a threshold; and
based at least in part on the fallback condition, terminating transmission of the information indicative of the one or more RS configurations to recommend to the wireless network entity for incremental CSI estimation.

10. The method of claim 1, further comprising:
generating a report comprising information indicative of the one or more RS configurations to recommend to the wireless network entity for incremental CSI estimation in one of a compressed mode, an uncompressed mode, or entries in a table; and
transmitting, to the wireless network entity, the report.

11. A wireless transmit/receive unit (WTRU) comprising:
a processer; and
a transceiver, wherein the WTRU is configured to:
receive, from a wireless network entity, first configuration information for performing task measurements and for determining incremental channel state information (CSI);
receive, from the wireless network entity, a first reference signal (RS);
perform task measurements based on the 1) first RS and 2) the first configuration information;
determine incremental CSI based on the 1) first RS and 2) the first configuration information, wherein the incremental CSI comprises:
long-term magnitude information over a first interval of the RS; and
short-term magnitude information over a second interval of the RS that is shorter than the first interval;
determine one or more RS configurations to recommend to the wireless network entity for incremental CSI estimation based on the incremental CSI; and
transmit, to the wireless network entity, information indicative of the one or more RS configurations to recommend to the wireless network entity for incremental CSI estimation.

12. The WTRU of claim 11, wherein task measurements comprise one or more of sensing measurements, positioning measurements, communication measurements, or incremental CSI measurements.

13. The WTRU of claim 11, wherein the first interval comprises a duration over one or more symbol intervals.

14. The WTRU of claim 11, wherein the second interval comprises a duration over a subset of a symbol interval.

15. The WTRU of claim 11, wherein the first configuration information comprises at least one of CSI variation metrics, target values of multipath delay error and channel estimation error, maximum CSI variation, long-term and short-term CSI magnitudes per sub-symbol interval, or available RS configurations for incremental CSI estimation.

16. The WTRU of claim 15, wherein CSI variation metrics comprise at least one of a change in one or more of a phase, reference signal received power (RSRP), reference signal received power per path (RSRPP), time of arrival (ToA), angle of arrival (AoA), or radar cross section (RCS) within a measurement window of one or more of a target line of sight (LOS) or multipath component (MPC).

17. The WTRU of claim 11, wherein the long-term magnitude information comprises one or more of an RS pattern for long-term CSI estimation, an RS frequency region, an RS bandwidth based on a delay estimation uncertainty, or an RS periodicity based on a difference between multipath delays.

18. The WTRU of claim 11, wherein the short-term magnitude information comprises at least one of an RS pattern for short-term CSI estimation, an RS sub-symbol interval size, an RS frequency region, an RS bandwidth based on the number of multipaths, an RS guard bandwidth based on Doppler and phase noise spread, or an RS periodicity based on a channel's coherence time.

19. The WTRU of claim 11, wherein the WTRU is further configured to:
determine a fallback condition for transmitting information indicative of the one or more RS configurations to recommend to the wireless network entity for incremental CSI estimation, wherein the fallback condition is based at least in part on a CSI variation metric being below a threshold; and
based at least in part on the fallback condition, terminate transmission of the information indicative of the one or more RS configurations to recommend to the wireless network entity for incremental CSI estimation.

20. The WTRU of claim 11, wherein the WTRU is further configured to:
generate a report comprising information indicative of the one or more RS configurations to recommend to the wireless network entity for incremental CSI estimation in one of a compressed mode, an uncompressed mode, or entries in a table; and
transmit, to the wireless network entity, the report.
